(19) United States
(12) Patent Application Publication
(10) Pub. No.: US 2012/0110043 A1
(43) Pub. Date: May 3, 2012

(54) MEDIA ASSET MANAGEMENT

(75) Inventors: Rene Cavet, Darmstadt (DE); Joshua Cohen, Frankfurt (DE); Nicolas Ley, Darmstadt (DE)

(73) Assignee: iPharro Media GmbH

(21) Appl. No.: 13/150,894

(22) Filed: Jun. 1, 2011

Related U.S. Application Data
(63) Continuation of application No. 12/937,459.
(60) Provisional application No. 61/044,506, filed on Apr. 13, 2008.

(51) Int. Cl. G06F 17/30

(52) U.S. Cl. 707/825; 707/E17.143

(57) ABSTRACT

In some embodiments, the technology includes systems and methods for media asset management. In other embodiments, a method for media asset management includes receiving media data. The method for media asset management further includes generating a descriptor based on the media data and comparing the descriptor with one or more stored descriptors. The one or more stored descriptors are associated with other media data that has related metadata. The method for media asset management further includes associating at least part of the metadata with the media data based on the comparison of the descriptor and the one or more stored descriptors.

### FIELD OF THE INVENTION

The present invention relates to media asset management. Specifically, the present invention relates to metadata management for video content.

### BACKGROUND

The availability of broadband communication channels to end-user devices has enabled ubiquitous media coverage with image, audio, and video content. The increasing amount of media content that is transmitted globally has boosted the need for intelligent content management. Providers must organize their content and be able to analyze their content. Similarly, broadcasters and market researchers want to know when and where specific footage has been broadcast. Content monitoring, market trend analysis, copyright protection, and asset management are challenging, if not impossible, due to the increasing amount of media content. However, a need exists to improve media asset management in this technology field.

### SUMMARY

In some aspects, the technology includes a method of media asset management. The method includes receiving second media data. The method further includes generating a second descriptor based on the second media data. The method further includes comparing the second descriptor with a first descriptor. The first descriptor is associated with first media data having related metadata. The method further includes associating at least part of the metadata with the second media data based on the comparison of the second descriptor and the first descriptor.

In other aspects, the technology includes a method of media asset management. The method includes generating a second descriptor based on second media data. The method further includes transmitting a request for metadata associated with the second media data. The request includes the second descriptor. The method further includes receiving metadata based on the request. The metadata is associated with at least part of a first media data. The method further includes associating the metadata with the second media data based on a comparison of the second descriptor and a first descriptor associated with the first media data.

In some aspects, the technology includes a method of media asset management. The method includes transmitting a request for metadata associated with second media data. The request includes the second media data. The method further includes receiving metadata based on the request. The metadata is associated with at least part of first media data. The method further includes associating the metadata with the second media data based on a comparison of the second descriptor and a first descriptor associated with the first media data.

In other aspects, the technology includes a computer program product. The computer program product is tangibly embodied in an information carrier. The computer program product includes instructions being operable to cause a data processing apparatus to receive second media data, generate a second descriptor based on the second media data, compare the second descriptor with a first descriptor, and associate at least part of the metadata with the second media data based on the comparison of the second descriptor and the first descriptor. The first descriptor is associated with first media data having related metadata.

In some aspects of the technology, the technology includes a system of media asset management. The system includes a communication module, a media fingerprint module, a media fingerprint comparison module, and a media metadata module. The communication module receives second media data. The media fingerprint module generates a second descriptor based on the second media data. The media fingerprint comparison module compares the second descriptor and a first descriptor. The first descriptor is associated with a first media data having related metadata. The media metadata module associates at least part of the metadata with the second media data based on the comparison of the second descriptor and the first descriptor.

In other aspects, the technology includes a system of media asset management. The system includes a communication module, a media fingerprint module, and a media metadata module. The media fingerprint module generates a second descriptor based on second media data. The communication module transmits a request for metadata associated with the second media data and receives the metadata based on the request. The request includes the second descriptor. The metadata is associated with at least part of the first media data. The media metadata module associates metadata with the second media data based on a comparison of the second descriptor and a first descriptor associated with first media data.

In some aspects, the technology includes a system of media asset management. The system includes a communication module and a media metadata module. The communication module transmits a request for metadata associated with second media data and receives metadata based on the request. The request includes the second media data. The metadata is associated with at least part of first media data. The media metadata module associates the metadata with the second media data based on a comparison of the second descriptor and a first descriptor associated with the first media data.

In other aspects, the technology includes a system of media asset management. The system includes a means for receiving second media data and a means for generating a second descriptor based on the second media data. The system further includes a means for comparing the second descriptor and a first descriptor. The first descriptor is associated with a first media data having related metadata. The system further includes a means for associating at least part of the metadata with the second media data based on the comparison of the second descriptor and the first descriptor.

Any of the aspects described above can include one or more of the following features and/or examples. In some examples, the method further includes determining one or more second boundaries associated with the second media data and generating one or more second descriptors based on the second media data and the one or more second boundaries.

In other examples, the method further includes comparing the one or more second descriptors and one or more first descriptors. Each of the one or more first descriptors can be associated with one or more first boundaries associated with the first media data.

In some examples, the one or more second boundaries includes a spatial boundary and/or a temporal boundary.

In other examples, the method further includes separating the second media data into one or more second media data sub-parts based on the one or more second boundaries.

In some examples, the method further includes associating at least part of the metadata with at least one of the one or more second media data sub-parts based on the comparison of the second descriptor and the first descriptor.

In other examples, the second media data includes all or part of the first media data.

In some examples, the second descriptor is similar to part or all of the first descriptor.

In other examples, the method further includes receiving the first media data and the metadata associated with the first media data and generating the first descriptor based on the first media data.

In some examples, the method further includes associating at least part of the metadata with the first descriptor.

In other examples, the method further includes storing the metadata, the first descriptor, and the association of the at least part of the metadata with the first descriptor and retrieving the stored metadata, the stored first descriptor, and the stored association of the at least part of the metadata with the first descriptor.

In some examples, the method further includes determining one or more first boundaries associated with the first media data and generating one or more first descriptors based on the first media data and the one or more first boundaries.

In other examples, the method further includes separating the metadata associated with the first media data into one or more metadata sub-parts based on the one or more first boundaries and associating the one or more metadata sub-parts with the one or more first descriptors based on the one or more first boundaries.

In some examples, the method further includes associating the metadata and the first descriptor.

In other examples, the first media data includes video.

In some examples, the first media data includes video, audio, text, and/or an image.

In other examples, the second media data includes all or part of first media data.

In some examples, the second descriptor is similar to part or all of the first descriptor.

In other examples, the first media data includes video.

In some examples, the first media data includes video, audio, text, and/or an image.

In other examples, the second media data includes all or part of the first media data.

In some examples, the second descriptor is similar to part or all of the first descriptor.

In other examples, the system further includes a video frame conversion module to determine one or more second boundaries associated with the second media data and the media fingerprint module to generate one or more second descriptors based on the second media data and the one or more second boundaries.

In some examples, the system further includes the media fingerprint comparison module to compare the one or more second descriptors and one or more first descriptors. Each of the one or more first descriptors can be associated with one or more first boundaries associated with the first media data.

In other examples, the system further includes the video frame conversion module to separate the second media data into one or more second media data sub-parts based on the one or more second boundaries.

In some examples, the system further includes the media metadata module to associate at least part of the metadata with at least one of the one or more second media data sub-parts based on the comparison of the second descriptor and the first descriptor.

In other examples, the system further includes the communication module to receive the first media data and the metadata associated with the first media data and the media fingerprint module to generate the first descriptor based on the first media data.

In some examples, the system further includes the media metadata module to associate at least part of the metadata with the first descriptor.

In other examples, the system further includes a storage device to store the metadata, the first descriptor, and the association of the at least part of the metadata with the first descriptor and retrieve the stored metadata, the stored first descriptor, and the stored association of the at least part of the metadata with the first descriptor.

In some examples, the system further includes the video conversion module to determine one or more first boundaries associated with the first media data and the media fingerprint module to generate one or more first descriptors based on the first media data and the one or more first boundaries.

In other examples, the system further includes the video conversion module to separate the metadata associated with the first media data into one or more metadata sub-parts based on the one or more first boundaries and the media metadata module to associate the one or more metadata sub-parts with the one or more first descriptors based on the one or more first boundaries.

In some examples, the system further includes the media metadata module to associate the metadata and the first descriptor.

The media asset management described herein can provide one or more of the following advantages. An advantage of the media asset management is that the association of the metadata enables the incorporation of the metadata into the complete workflow of media, i.e., from production through future re-use, thereby increasing the opportunities for re-use of the media. Another advantage of the media asset management is that the association of the metadata lowers the cost of media production by enabling re-use and re-purposing of archived media via the quick and accurate metadata association.

An additional advantage of the media asset management is that the media and its associated metadata can be efficiently searched and browsed thereby lowering the barriers for use of media. Another advantage of the media asset management is that metadata can be found in a large media archive by quickly and efficiently comparing the unique descriptors of the media with the stored descriptors of the media stored in the media archive thereby enabling the quick and efficient association of the correct metadata, i.e., media asset management.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 illustrates a functional block diagram of an exemplary system;

FIG. 2 illustrates a functional block diagram of an exemplary content analysis server;

FIG. 3 illustrates a functional block diagram of an exemplary communication device in a system;

FIG. 4 illustrates an exemplary flow diagram of a generation of a digital video fingerprint;

FIG. 5 illustrates an exemplary flow diagram of a generation of a fingerprint;

FIG. 6 illustrates an exemplary flow diagram of an association of metadata;

FIG. 7 illustrates another exemplary flow diagram of an association of metadata;

FIG. 8 illustrates an exemplary data flow diagram of an association of metadata;

FIG. 9 illustrates another exemplary table illustrating association of metadata;

FIG. 10 illustrates an exemplary data flow diagram of an association of metadata;

FIG. 11 illustrates another exemplary table illustrating association of metadata;

FIG. 12 illustrates an exemplary flow chart for associating metadata;

FIG. 13 illustrates another exemplary flow chart for associating metadata;

FIG. 14 illustrates another exemplary flow chart for associating metadata;

FIG. 15 illustrates another exemplary flow chart for associating metadata;

FIG. 16 illustrates a block diagram of an exemplary multi-channel video monitoring system;

FIG. 17 illustrates a screen shot of an exemplary graphical user interface;

FIG. 18 illustrates an example of a change in a digital image representation subframe;

FIG. 19 illustrates an exemplary flow chart for the digital video image detection system; and

FIGS. 20A-20B illustrate an exemplary traversed set of K-NN nested, disjoint feature subspaces in feature space.

### DETAILED DESCRIPTION

By way of general overview, the technology compares media content (e.g., digital footage such as films, clips, and advertisements, digital media broadcasts, etc.) to other media content to associate metadata (e.g., information about the media, rights management data about the media, etc.) with the media content via a content analyzer. The media content can be obtained from virtually any source able to store, record, or play media (e.g., a computer, a mobile computing device, a live television source, a network server source, a digital video disc source, etc.). The content analyzer enables automatic and efficient comparison of digital content to identify metadata associated with the digital content. For example, original metadata from source video may be lost or otherwise corrupted during the course of routine video editing. By comparing descriptors of portions the edited video to descriptors of the source video, the original metadata can be associated with or otherwise restored in the resulting edited video. The content analyzer can be a content analysis processor or server, is highly scalable and can use computer vision and signal processing technology for analyzing footage in the video and in the audio domain in real time.

Moreover, the content analysis server's automatic content analysis and metadata technology is highly accurate. While human observers may err due to fatigue, or miss small details in the footage that are difficult to identify, the content analysis server is routinely capable of comparing content with an accuracy of over 99% so that the metadata can be advantageously associated with the content to re-populate the metadata for media. The comparison of the content and the association of the metadata does not require prior inspection or manipulation of the footage to be monitored. The content analysis server extracts the relevant information from the media stream data itself and can therefore efficiently compare a nearly unlimited amount of media content without manual interaction.

The content analysis server generates descriptors, such as digital signatures—also referred to herein fingerprints—from each sample of media content. Preferably, the descriptors uniquely identify respective content segments. For example, the digital signatures describe specific video, audio and/or audiovisual aspects of the content, such as color distribution, shapes, and patterns in the video parts and the frequency spectrum in the audio stream. Each sample of media has a unique fingerprint that is basically a compact digital representation of its unique video, audio, and/or audiovisual characteristics.

The content analysis server utilizes such descriptors, or fingerprints, to associate metadata from the same and/or similar frame sequences or clips in a media sample as illustrated in Table 1. In other words, in this example, the content analysis server receives the media A and the associated metadata, generates the fingerprints for the media A, and stores the fingerprints for the media A and the associated metadata. Near the same time or at a later time, in this example, the content analysis server receives media B, generates the fingerprints for media B, compares the fingerprints for media B with the stored fingerprints for media A, and associates the stored metadata from media A with the media B based on the comparison of the fingerprints.

TABLE 1
Exemplary Association Process

| | | | | | | Associated |
|---|---|---|---|---|---|---|
| Media A | Fingerprint | Metadata | Media B | Fingerprint | Result | Metadata |
| Sequence | 123AA258 | Little Bugs | Sequence | 123AA258 | Similar | Little Bugs |
| A1 | | Movie; XYZ | B4 | | | Movie; XYZ |
| | | Studio | | | | Studio |
| Sequence | 456AA258 | Bug | | | No | NA |
| A2 | | Commercial; | | | Matches | |
| | | Bug Company | | | | |
| Sequence | 123BB258 | Little Bugs | Sequence | 123BB258 | Similar | Little Bugs |
| A3 | | Movie; XYZ | B5 | | | Movie; XYZ |
| | | Studio | | | | Studio |
| Sequence | 123CC258 | Big Pest | | | No | NA |
| A4 | | Commercial; | | | Matches | |
| | | Big Pest | | | | |
| | | Company | | | | |
| Sequence | 123DD258 | Public Service | Sequence | 123DD258 | Similar | Public Service |
| A5 | | Announcement | B9 | | | Announcement |
| | | BB3 | | | | BB3 |
| Sequence | EE258456 | Little Bugs | Sequence | EE258456 | Similar | Little Bugs |
| A6 | | Movie; XYZ | B6 | | | Movie; XYZ |
| | | Studio | | | | Studio |
| Sequence | 123FF258 | Car | | | No | NA |
| A7 | | Commercial; | | | Matches | |
| | | Super Bug | | | | |
| | | Company | | | | |
| Sequence | 456GG258 | Car Service | | | No | NA |
| A8 | | Commercial; | | | Matches | |
| | | Best Bug Limo | | | | |
| Sequence | 123258HH | Little Bugs | Sequence | 123258HH | Similar | Little Bugs |
| A9 | | Movie; XYZ | B7 | | | Movie; XYZ |
| | | Studio | | | | Studio |

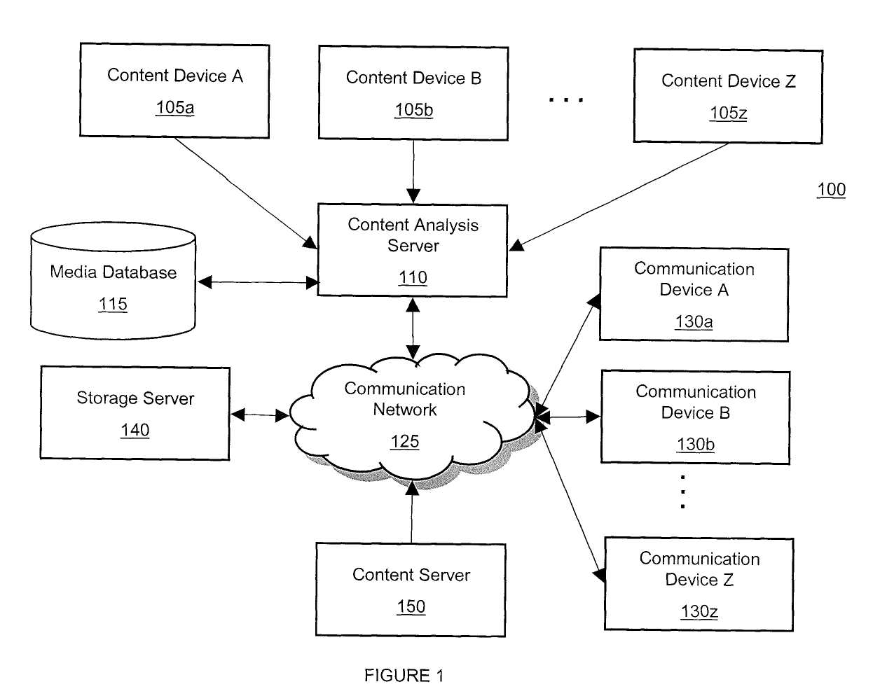

FIG. 1 illustrates a functional block diagram of an exemplary system 100. The system 100 includes one or more content devices A 105a, B 105b through Z 105z (hereinafter referred to as content devices 105), a content analyzer, such as a content analysis server 110, a communications network 125, a media database 115, one or more communication devices A 130a, B 130b through Z 130z (hereinafter referred to as communication device 105), a storage server 140, and a content server 150. The devices, databases, and/or servers communicate with each other via the communication network 125 and/or via connections between the devices, databases, and/or servers (e.g., direct connection, indirect connection, etc.).

The content analysis server 110 requests and/or receives media data—including, but not limited to, media streams, multimedia, and/or any other type of media (e.g., video, audio, text, etc.)—from one or more of the content devices 105 (e.g., digital video disc device, signal acquisition device, satellite reception device, cable reception box, etc.), the communication device 130 (e.g., desktop computer, mobile computing device, etc.), the storage server 140 (e.g., storage area network server, network attached storage server, etc.), the content server 150 (e.g., internet based multimedia server, streaming multimedia server, etc.), and/or any other server or device that can store a multimedia stream. The content analysis server 110 can identify one or more segments, e.g., frame sequences, for the media stream. The content analysis server 110 can generate a fingerprint for each of the one or more frame sequences in the media stream and/or can generate a fingerprint for the media stream. The content analysis server 110 compares the fingerprints of one or more frame sequences of the media stream with one or more stored fingerprints associated with other media. The content analysis server 110 associates metadata of the other media with the media stream based on the comparison of the fingerprints.

In other examples, the communication device 130 requests metadata associated with media (e.g., a movie, a television show, a song, a clip of media, etc.). The communication device 130 transmits the request to the content analysis server 110. The communication device 130 receives the metadata from the content analysis server 110 in response to the request. The communication device 130 associates the received metadata with the media. For example, the metadata includes copyright information regarding the media which is now associated with the media for future use. The association of metadata with media advantageously enables information about the media to be re-associated with the media which enables users of the media to have accurate and up-to-date information about the media (e.g., usage requirements, author, original date/time of use, copyright restrictions, copyright ownership, location of recording of media, person in media, type of media, etc.).

In some examples, the metadata is stored via the media database 115 and/or the content analysis server 110. The content analysis server 110 can receive media data (e.g., multimedia data, video data, audio data, etc.) and/or metadata associated with the media data (e.g., text, encoded information, information within the media stream, etc.). The content analysis server 110 can generate a descriptor based on the media data (e.g., unique fingerprint of media data, unique fingerprint of part of media data, etc.). The content analysis server 110 can associate the descriptor with the metadata (e.g., associate copyright information with unique fingerprint of part of media data, associate news network with descriptor of news clip media, etc.). The content analysis server 110 can store the media data, the metadata, the descriptor, and/or the association between the metadata and the descriptor via a storage device (not shown) and/or the media database 115.

In other examples, the content analysis server 110 generates a fingerprint for each frame in each multimedia stream. The content analysis server 110 can generate the fingerprint for each frame sequence (e.g., group of frames, direct sequence of frames, indirect sequence of frames, etc.) for each multimedia stream based on the fingerprint from each frame in the frame sequence and/or any other information associated with the frame sequence (e.g., video content, audio content, metadata, etc.).

In some examples, the content analysis server 110 generates the frame sequences for each multimedia stream based on information about each frame (e.g., video content, audio content, metadata, fingerprint, etc.).

In other examples, the metadata is stored in embedded into the media (e.g., embedded in the media stream, embedded into a container for the media, etc.) and/or stored separately from the media (e.g., stored in a database with a link between the metadata and the media, stored in a corresponding file on a storage device, etc.). The metadata can be, for example, stored and/or processed via a material exchange format (MXF), a broadcast media exchange format (BMF), a multimedia content description interface (MPEG-7), an extensible markup language format (XML), and/or any other type of format.

Although FIG. 1 illustrates the communication device 130 and the content analysis server 110 as separate, part or all of the functionality and/or components of the communication device 130 and/or the content analysis server 110 can be integrated into a single device/server (e.g., communicate via intra-process controls, different software modules on the same device/server, different hardware components on the same device/server, etc.) and/or distributed among a plurality of devices/servers (e.g., a plurality of backend processing servers, a plurality of storage devices, etc.). For example, the communication device 130 can generate descriptors and/or associate metadata with media and/or the descriptors. As another example, the content analysis server 110 includes an user interface (e.g., web-based interface, stand-alone application, etc.) which enables a user to communicate media to the content analysis server 110 for association of metadata.

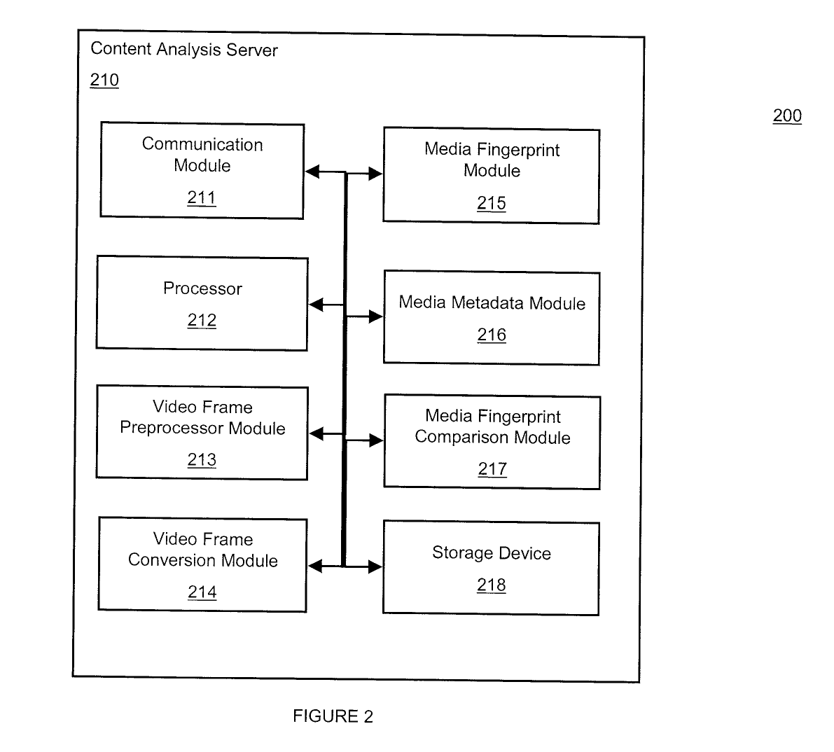

FIG. 2 illustrates a functional block diagram of an exemplary content analysis server 210 in a system 200. The content analysis server 210 includes a communication module 211, a processor 212, a video frame preprocessor module 213, a video frame conversion module 214, a media fingerprint module 215, a media metadata module 216, a media fingerprint comparison module 217, and a storage device 218.

The communication module 211 receives information for and/or transmits information from the content analysis server 210. The processor 212 processes requests for comparison of multimedia streams (e.g., request from a user, automated request from a schedule server, etc.) and instructs the communication module 211 to request and/or receive multimedia streams. The video frame preprocessor module 213 preprocesses multimedia streams (e.g., remove black border, insert stable borders, resize, reduce, selects key frame, groups frames together, etc.). The video frame conversion module 214 converts the multimedia streams (e.g., luminance normalization, RGB to Color9, etc.).

The media fingerprint module 215 generates a fingerprint for each key frame selection (e.g., each frame is its own key frame selection, a group of frames have a key frame selection, etc.) in a multimedia stream. The media metadata module 216 associates metadata with media and/or determines the metadata from media (e.g., extracts metadata from media, determines metadata for media, etc.). The media fingerprint comparison module 217 compares the frame sequences for multimedia streams to identify similar frame sequences between the multimedia streams (e.g., by comparing the fingerprints of each key frame selection of the frame sequences, by comparing the fingerprints of each frame in the frame sequences, etc.). The storage device 218 stores a request, media, metadata, a descriptor, a frame selection, a frame sequence, a comparison of the frame sequences, and/or any other information associated with the association of metadata.

In some examples, the video frame conversion module 214 determines one or more boundaries associated with the media data. The media fingerprint module 217 generates one or more descriptors based on the media data and the one or more boundaries. Table 2 illustrates the boundaries determined by an embodiment of the video frame conversion module 214 for a television show “Why Dogs are Great.”

TABLE 2
Exemplary Boundaries and Descriptors for Television Show

| Boundary | Boundary | | |
|---|---|---|---|
| Start | End | Descriptor | Metadata |
| 00:00:00 | 03:34:43 | Alpha45c | Television Show “Why Dogs are |
| | | | Great”; Part C; Episode: Dogs all |
| | | | over the World |
| 03:34:44 | 05:42:22 | Alpha45d | Television Show “Why Dogs are |
| | | | Great”; Part D; Episode: Dogs all |
| | | | over North America |
| 05:42:23 | 06:42:22 | Alpha45e | Television Show “Why Dogs are |
| | | | Great”; Part E; Episode: Dogs all |
| | | | over South America |
| 06:42:23 | 08:23:23 | Alpha45g | Television Show “Why Dogs are |
| | | | Great”; Part F; Episode: Dogs all |
| | | | over Africa |

In other examples, the media fingerprint comparison module 217 compares the one or more descriptors and one or more other descriptors. Each of the one or more other descriptors can be associated with one or more other boundaries associated with the other media data. For example, the media fingerprint comparison module 217 compares the one or more descriptors (e.g., Alpha 45e, Alpha 45g, etc.) with stored descriptors. The comparison of the descriptors can be, for example, an exact comparison (e.g., text to text comparison, bit to bit comparison, etc.), a similarity comparison (e.g., descriptors are within a specified range, descriptors are within a percentage range, etc.), and/or any other type of comparison. The media fingerprint comparison module 217 can, for example, associate metadata with the media data based on exact matches of the descriptors and/or can associate part or all of the metadata with the media data based on a similarity match of the descriptors. Table 3 illustrates the comparison of the descriptors with other descriptors.

TABLE 3
Exemplary Comparison of Descriptors

| | Stored | | | |
|---|---|---|---|---|
| Descriptor | Descriptors | Stored Metadata | Result | Associated Metadata |
| Alpha45g | Alpha45a | Television Show “Why Dogs | Similar | Television Show “Why Dogs |
| | | are Great”; Part A | | are Great” |
| | Alpha45b | Television Show “Why Dogs | Similar | Television Show “Why Dogs |
| | | are Great”; Part B | | are Great” |
| | Beta34a | Television Show “Why Cats | No Match | NA |
| | | are Great”; Part A | | |
| | Beta34b | Television Show “Why Cats | No Match | NA |
| | | are Great”; Part B | | |
| | Alpha45g | Television Show “Why Dogs | Match | Television Show “Why Dogs |
| | | are Great”; Part G | | are Great”; Part G |
| Beta45c | Alpha45a | Television Show “Why Dogs | No Match | NA |
| | | are Great”; Part A | | |
| | Alpha45b | Television Show “Why Dogs | No Match | NA |
| | | are Great”; Part B | | |
| | Beta34a | Television Show “Why Cats | Similar | Television Show “Why Cats are |
| | | are Great”; Part A | | Great” |
| | Beta34b | Television Show “Why Cats | Similar | Television Show “Why Cats are |
| | | are Great”; Part B | | Great” |
| | Alpha45g | Television Show “Why Dogs | No Match | NA |
| | | are Great”; Part G | | |

In other examples, the video frame conversion module 214 separates the media data into one or more media data sub-parts based on the one or more boundaries. In some examples, the media metadata module 216 associates at least part of the metadata with at least one of the one or more media data sub-parts based on the comparison of the descriptor and the other descriptor. For example, a televised movie can be split into sub-parts based on the movie sub-parts and the commercial sub-parts as illustrated in Table 1.

In some examples, the communication module 211 receives the media data and the metadata associated with the media data. The media fingerprint module 215 generates the descriptor based on the media data. For example, the communication module 211 receives the media data, in this example, a movie, from a digital video disc (DVD) player and the metadata from an internet movie database. In this example, the media fingerprint module 215 generates a descriptor of the movie and associates the metadata with the descriptor.

In other examples, the media metadata module 216 associates at least part of the metadata with the descriptor. For example, the television show name is associated with the descriptor, but not the first air date.

In some examples, the storage device 218 stores the metadata, the first descriptor, and/or the association of the at least part of the metadata with the first descriptor. The storage device 218 can, for example, retrieve the stored metadata, the stored first descriptor, and/or the stored association of the at least part of the metadata with the first descriptor.

In some examples, the media metadata module 216 determines new and/or supplemental metadata for media by accessing third party information sources. The media metadata module 216 can request metadata associated with media from an internet database (e.g., internet movie database, internet music database, etc.) and/or a third party commercial database (e.g., movie studio database, news database, etc.). For example, the metadata associated with media (in this example, a movie) includes the title “All Dogs go to Heaven” and the movie studio “Dogs Movie Studio.” Based on the metadata, the media metadata module 216 requests additional metadata from the movie studio database, receives the additional metadata (in this example, release date: “Jun. 1, 1995”; actors: W of Gang McRuff and Ruffus T. Bone; running time: 2:03:32), and associates the additional metadata with the media.

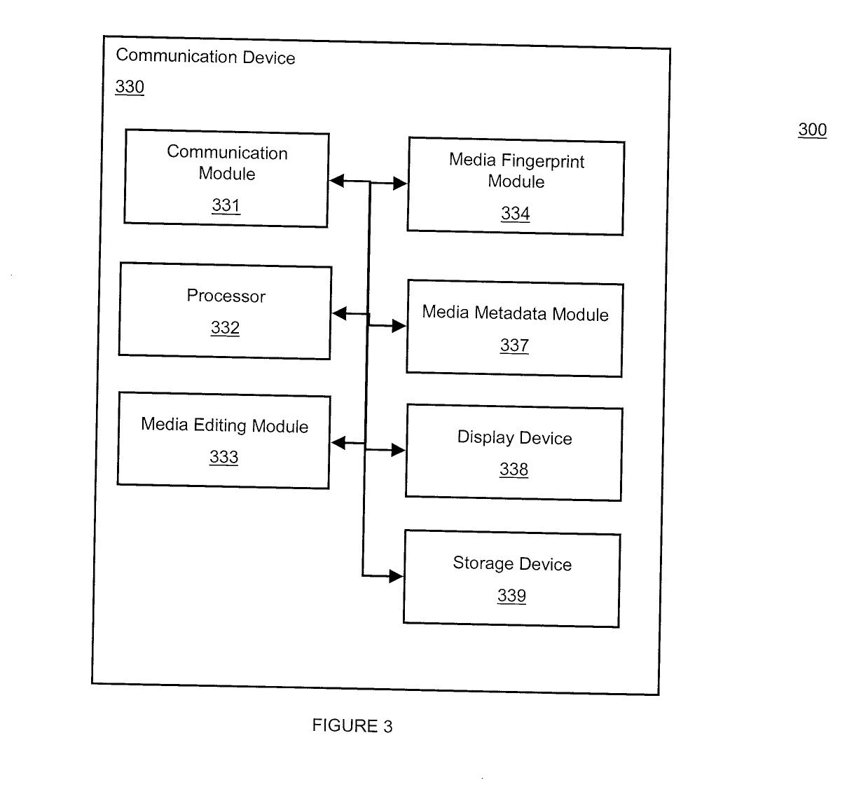

FIG. 3 illustrates a functional block diagram of an exemplary communication device 310 in a system 300. The communication device 310 includes a communication module 331, a processor 332, a media editing module 333, a media fingerprint module 334, a media metadata module 337, a display device 338 (e.g., a monitor, a mobile device screen, a television, etc.), and a storage device 339.

The communication module 311 receives information for and/or transmits information from the communication device 310. The processor 312 processes requests for comparison of media streams (e.g., request from a user, automated request from a schedule server, etc.) and instructs the communication module 311 to request and/or receive media streams.

The media fingerprint module 334 generates a fingerprint for each key frame selection (e.g., each frame is its own key frame selection, a group of frames have a key frame selection, etc.) in a media stream. The media metadata module 337 associates metadata with media and/or determines the metadata from media (e.g., extracts metadata from media, determines metadata for media, etc.). The display device 338 displays a request, media, metadata, a descriptor, a frame selection, a frame sequence, a comparison of the frame sequences, and/or any other information associated with the association of metadata. The storage device 339 stores a request, media, metadata, a descriptor, a frame selection, a frame sequence, a comparison of the frame sequences, and/or any other information associated with the association of metadata.

In other examples, the communication device 330 utilizes media editing software and/or hardware (e.g., Adobe Premiere available from Adobe Systems Incorporate, San Jose, Calif.; Corel VideoStudio® available from Corel Corporation, Ottawa, Canada, etc.) to manipulate and/or process the media. The editing software and/or hardware can include an application link (e.g., button in the user interface, drag and drop interface, etc.) to transmit the media being edited to the content analysis server 210 to associate the applicable metadata with the media, if possible.

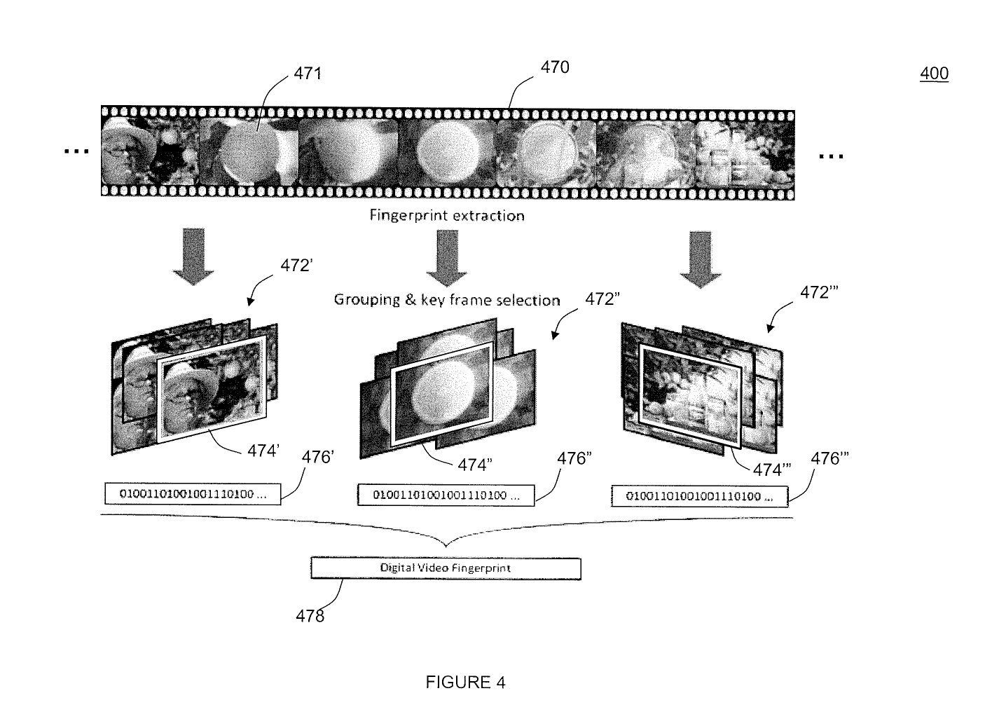

FIG. 4 illustrates an exemplary flow diagram 400 of a generation of a digital video fingerprint. The content analysis units fetch the recorded data chunks (e.g., multimedia content) from the signal buffer units directly and extract fingerprints prior to the analysis. The content analysis server 110 of FIG. 1 receives one or more video (and more generally audiovisual) clips or segments 470, each including a respective sequence of image frames 471. Video image frames are highly redundant, with groups frames varying from each other according to different shots of the video segment 470. In the exemplary video segment 470, sampled frames of the video segment are grouped according to shot: a first shot 472′, a second shot 472″, and a third shot 472″. A representative frame, also referred to as a key frame 474′, 474″, 474″ (generally 474) is selected for each of the different shots 472′, 472″, 472″ (generally 472). The content analysis server 100 determines a respective digital signature 476′, 476″, 476″ (generally 476) for each of the different key frames 474. The group of digital signatures 476 for the key frames 474 together represent a digital video fingerprint 478 of the exemplary video segment 470.

In some examples, a fingerprint is also referred to as a descriptor. Each fingerprint can be a representation of a frame and/or a group of frames. The fingerprint can be derived from the content of the frame (e.g., function of the colors and/or intensity of an image, derivative of the parts of an image, addition of all intensity value, average of color values, mode of luminance value, spatial frequency value). The fingerprint can be an integer (e.g., 345, 523) and/or a combination of numbers, such as a matrix or vector (e.g., [a, b], [x, y, z]). For example, the fingerprint is a vector defined by [x, y, z] where x is luminance, y is chrominance, and z is spatial frequency for the frame.

In some embodiments, shots are differentiated according to fingerprint values. For example in a vector space, fingerprints determined from frames of the same shot will differ from fingerprints of neighboring frames of the same shot by a relatively small distance. In a transition to a different shot, the fingerprints of a next group of frames differ by a greater distance. Thus, shots can be distinguished according to their fingerprints differing by more than some threshold value.

Thus, fingerprints determined from frames of a first shot 472′ can be used to group or otherwise identify those frames as being related to the first shot. Similarly, fingerprints of subsequent shots can be used to group or otherwise identify subsequent shots 472″, 472″. A representative frame, or key frame 474′, 474″, 474″ can be selected for each shot 472. In some embodiments, the key frame is statistically selected from the fingerprints of the group of frames in the same shot (e.g., an average or centroid).

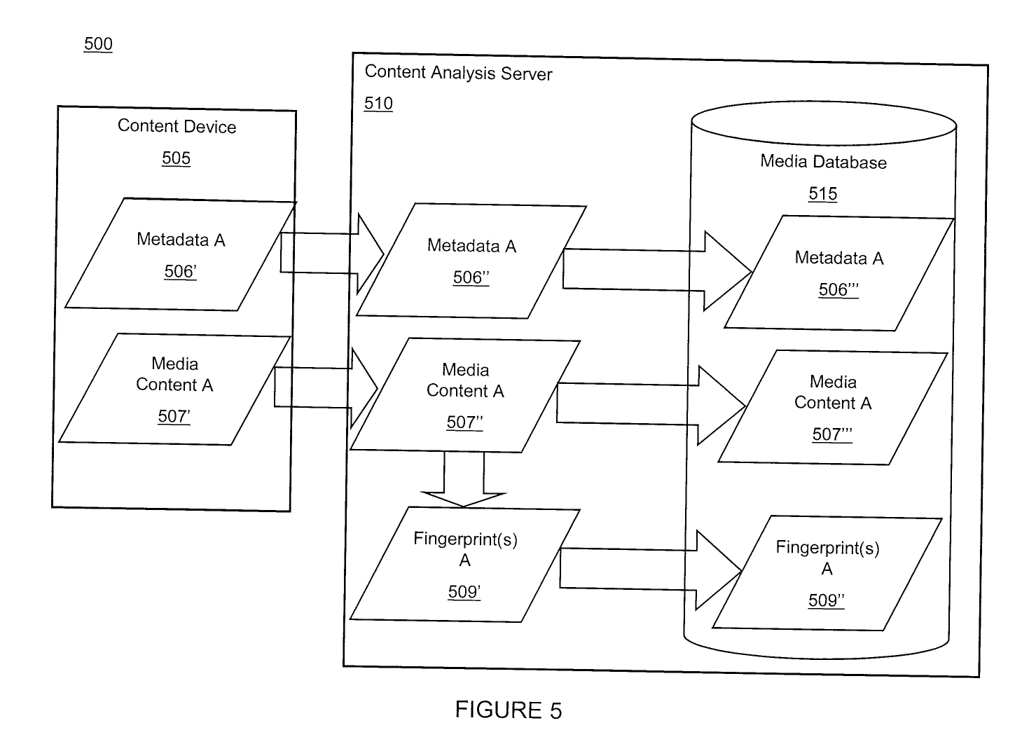

FIG. 5 illustrates an exemplary flow diagram 500 of a generation of a fingerprint. The flow diagram 500 includes a content device 505 and a content analysis server 510. The content analysis server 510 includes a media database 515. The content device 505 transmits metadata A 506′ and media content A 507′ to the content analysis server 510. The content analysis server 510 receives the metadata A 506″ and the media content A 507″. The content analysis server 510 generates one or more fingerprints A 509′ based on the media content A 507″. The content analysis server 510 stores the metadata A 506′″, the media content A 507′″, and the one or more fingerprints A 509″. In at least some embodiments, the content analysis server 510 records an association between the one or more fingerprints A509″ and the stored metadata A 506″.

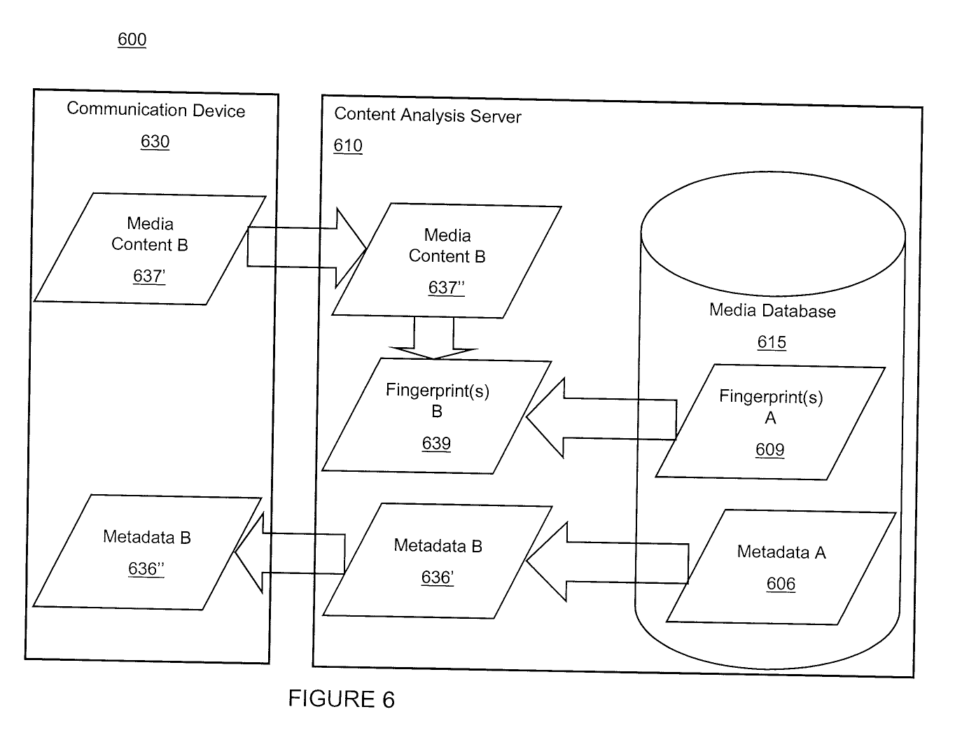

FIG. 6 illustrates an exemplary flow diagram 600 of an association of metadata. The flow diagram 600 includes a content analysis server 610 and a communication device 630. The content analysis server 610 includes a media database 615. The communication device 630 transmits media content B 637′ to the content analysis server 610. The content analysis server 610 generates one or more fingerprints B 639 based on the media content B 637″. The content analysis server 610 compares the one or more fingerprints B 638 and one or more fingerprints A 609 stored via the media database 615. The content analysis server 610 retrieves metadata A 606 stored via the media database 615. The content analysis server 610 generates metadata B 636′ based on the comparison of the one or more fingerprints B 638 and one or more fingerprints A 609 and/or the metadata A 606. The content analysis server 610 transmits the metadata B 636′ to the communication device 630. The communication device 630 associates the metadata B 636″ with the media content B 637′.

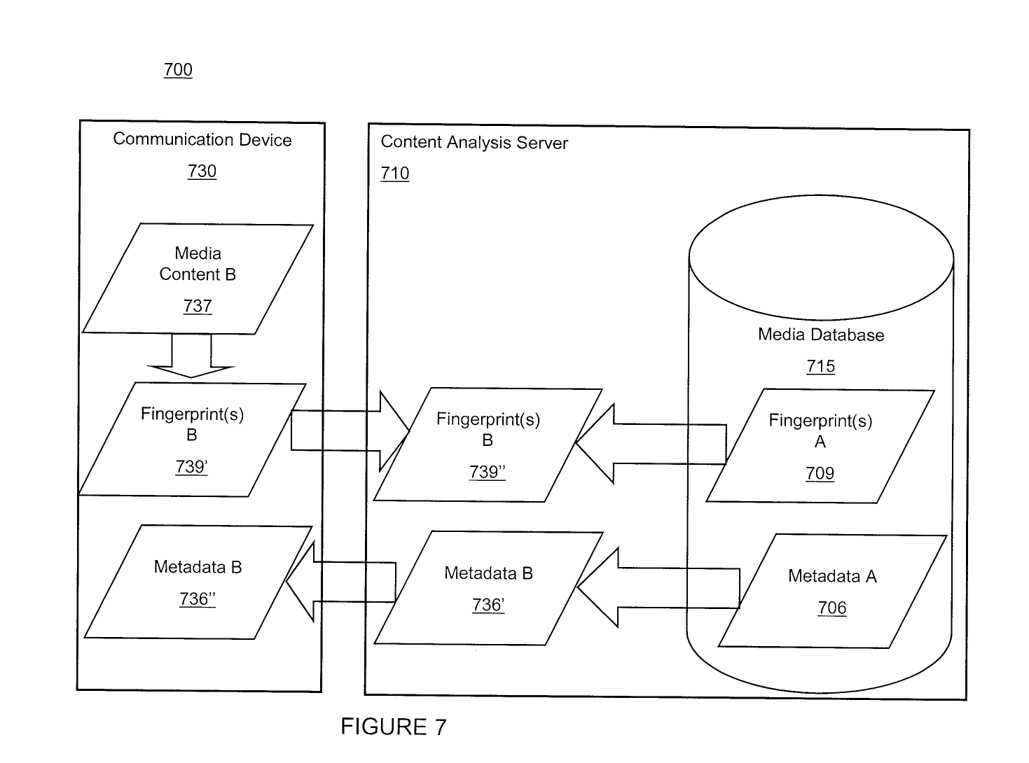

FIG. 7 illustrates another exemplary flow diagram 700 of an association of metadata. The flow diagram 700 includes a content analysis server 710 and a communication device 730. The content analysis server 710 includes a media database 715. The communication device 730 generates one or more fingerprints B 739′ based on media content B 737. The communication device 730 transmits the one or more fingerprints B 739′ to the content analysis server 710. The content analysis server 710 compares the one or more fingerprints B 739″ and one or more fingerprints A 709 stored via the media database 715. The content analysis server 710 retrieves metadata A 706 stored via the media database 715. The content analysis server 710 generates metadata B 736′ based on the comparison of the one or more fingerprints B 738″ and one or more fingerprints A 709 and/or the metadata A 706. For example, metadata B 736′ is generated (e.g., copied) from retrieved metadata A 706. The content analysis server 710 transmits the metadata B 736′ to the communication device 730. The communication device 730 associates the metadata B 736″ with the media content B 737.

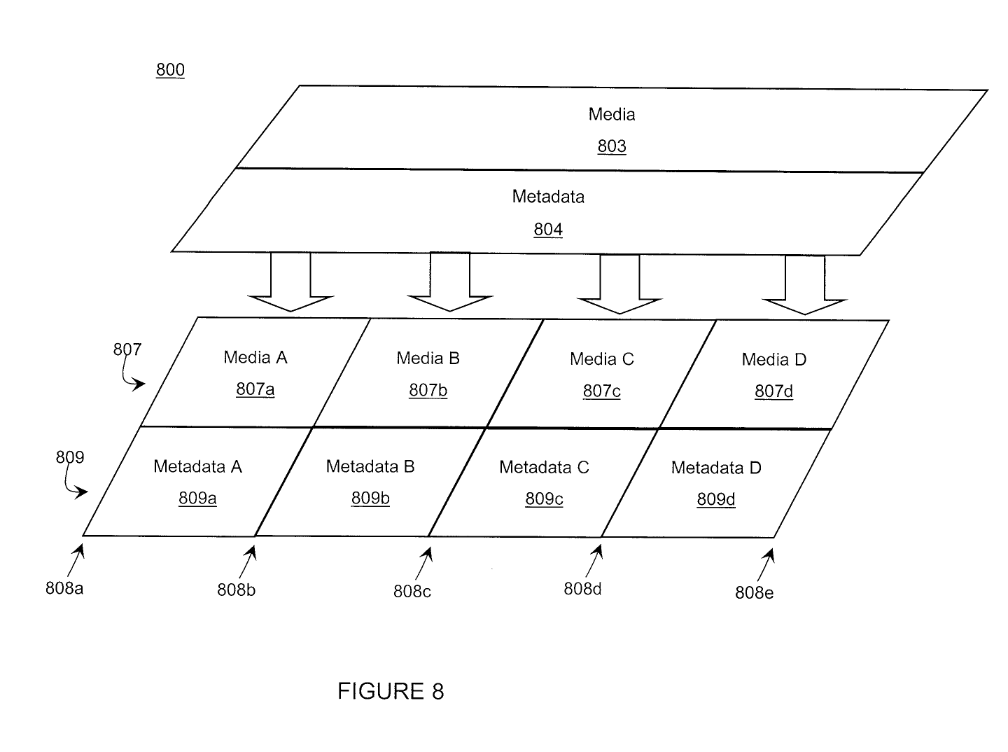

FIG. 8 illustrates an exemplary data flow diagram 800 of an association of metadata utilizing the system 200 of FIG. 2. The flow diagram 800 includes media 803 and metadata 804. The communication module 211 receives the media 803 and the metadata 804 (e.g., via the content device 105 of FIG. 1, via the storage device 218, etc.). The video frame conversion module 214 determines boundaries 808a, 808b, 808c, 808d, and 808e (hereinafter referred to as boundaries 808) associated with the media 807. The boundaries indicate the sub-parts of the media: media A 807a, media B 807b, media C 807c, and media D 807d. The media metadata module 216 associates part of the metadata 809 with each of the media sub-parts 807. In other words, metadata A 809a is associated with media A 807a; metadata B 809b is associated with media B 807b; metadata C 809c is associated with media C 807c; and metadata D 809d is associated with media D 807d.

In some examples, the video frame conversion module 214 determines the boundaries based on face detection, pattern recognition, speech to text analysis, embedded signals in the media, third party signaling data, and/or any other type of information that provides information regarding media boundaries.

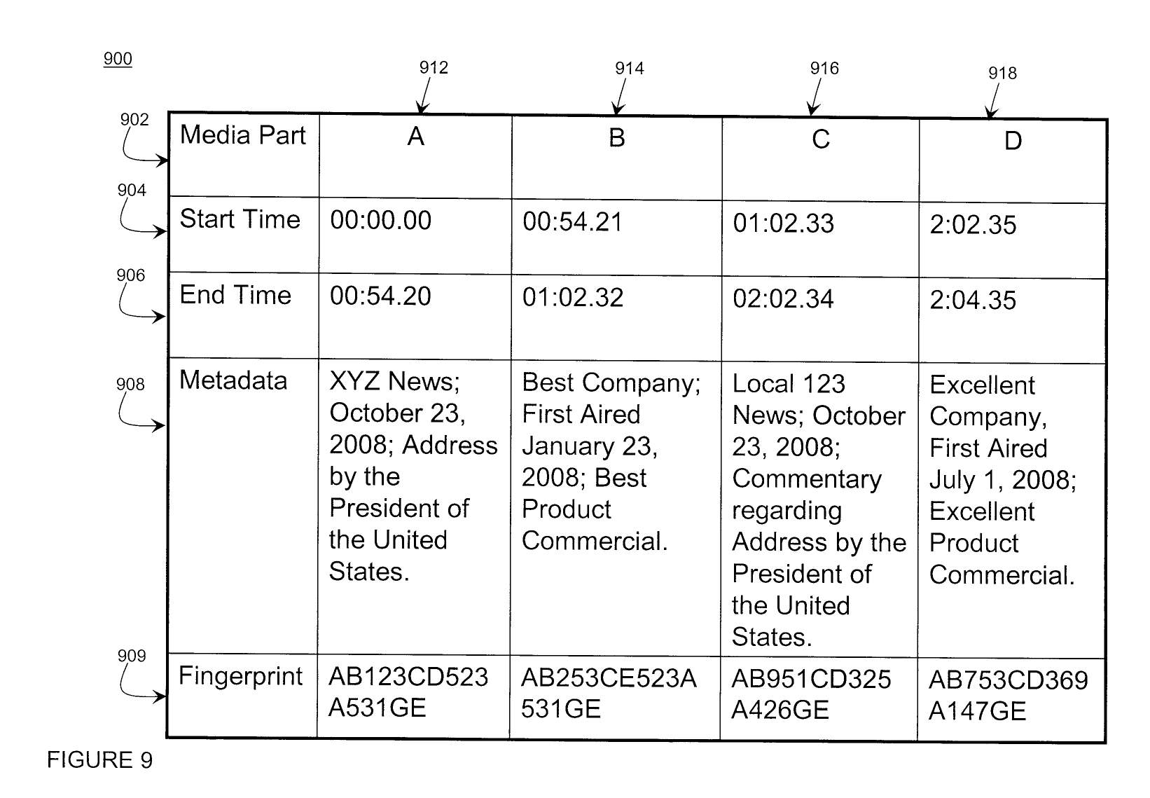

FIG. 9 illustrates another exemplary table 900 illustrating association of metadata as depicted in the flow diagram 800 of FIG. 8. The table 900 illustrates information regarding a media part 902, a start time 904, an end time 906, metadata 908, and a fingerprint 909. The table 900 includes the information for media sub-parts A 912, B 914, C 916, and D 918. The table 900 depicts the boundaries 808 of each media sub-part 809 utilizing the start time 904 and the end time 906. In other examples, the boundaries 808 of each media sub-part 809 are depicted utilizing frame numbers (e.g., start frame: 0 and end frame: 34, frame: 0+42, etc.) and/or any other type of location designation (e.g., track number, chapter number, episode number, etc.).

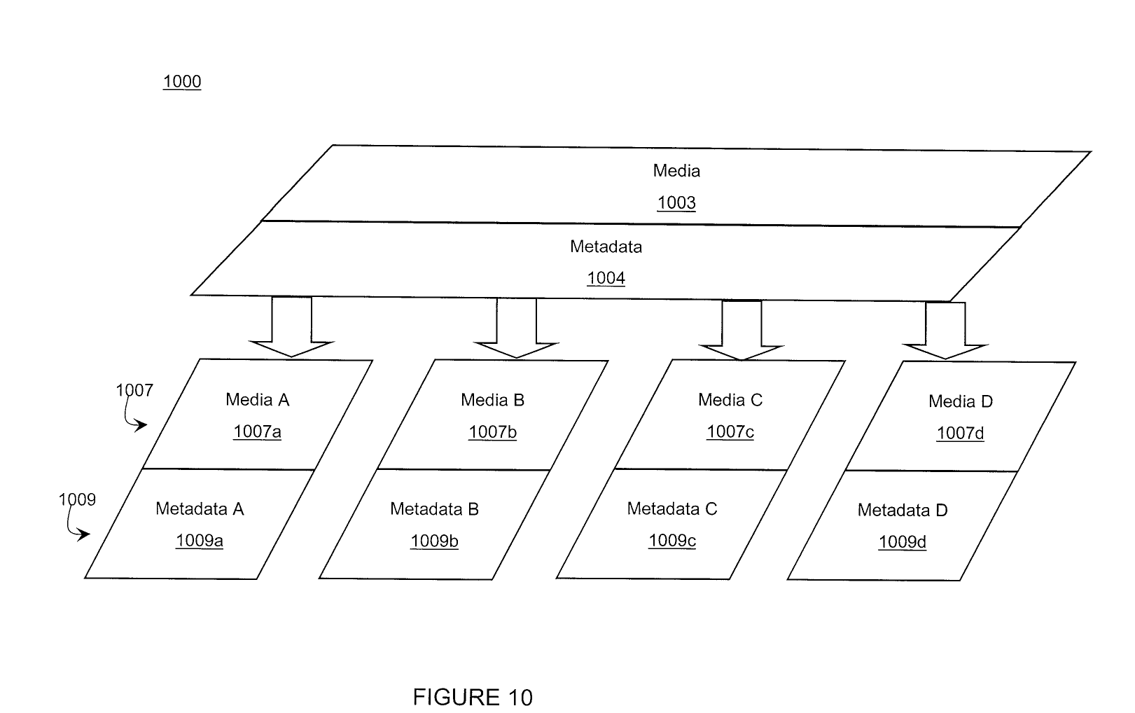

FIG. 10 illustrates an exemplary data flow diagram 1000 of an association of metadata utilizing the system 200 of FIG. 2. The flow diagram 1000 includes media 1003 and metadata 1004. The communication module 211 receives the media 1003 and the metadata 1004 (e.g., via the content device 105 of FIG. 1, via the storage device 218, etc.). The video frame conversion module 214 determines boundaries associated with the media 1007. The boundaries indicate the sub-parts of the media: media A 1007a, media B 1007b, media C 1007c, and media D 1007d. The video frame conversion module 214 separates the media 1007 into the sub-parts of the media. The media metadata module 216 associates part of the metadata 1009 with each of the separated media sub-parts 1007. In other words, metadata A 1009a is associated with media A 1007a; metadata B 1009b is associated with media B 1007b; metadata C 1009c is associated with media C 1007c; and metadata D 1009d is associated with media D 1007d.

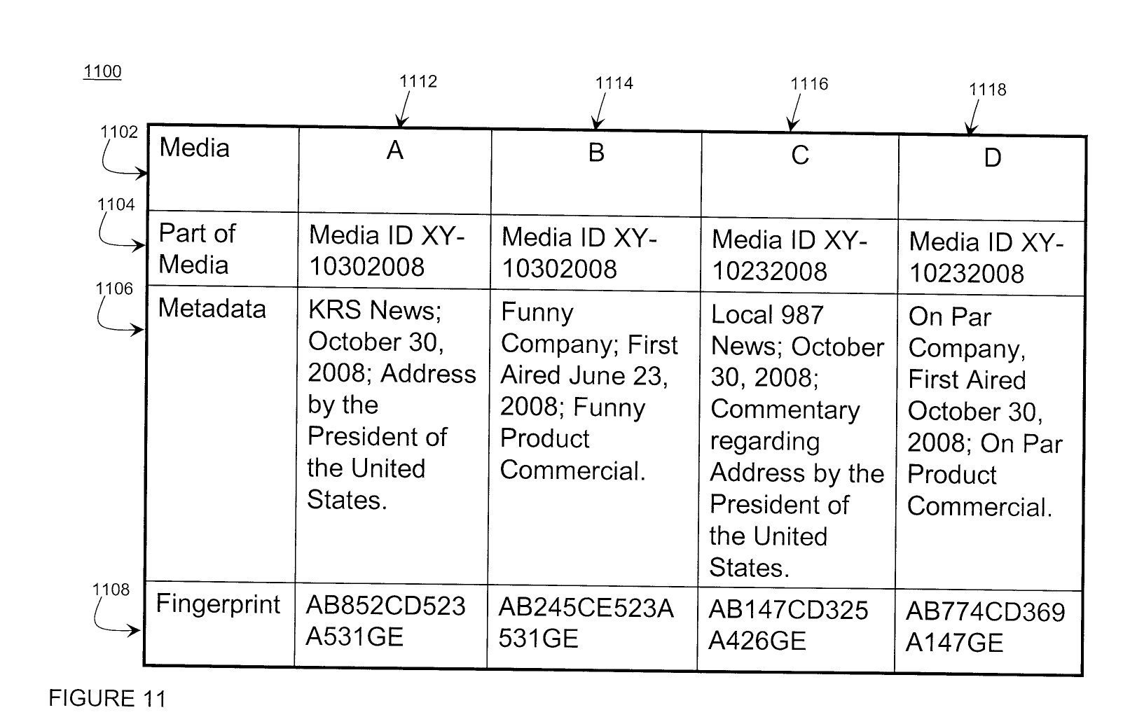

FIG. 11 illustrates another exemplary table 1100 illustrating association of metadata as depicted in the flow diagram 1000 of FIG. 10. The table 1100 illustrates information regarding a media part 1102, a reference to the original media 1104, metadata 1106, and a fingerprint 1108. The table 1100 includes the information for media sub-parts A 1112, B 1114, C 1116, and D 1118. The table 1100 depicts the separation of each media sub-parts 1007 as different parts that are associated with the original media, Media ID XY-10302008. The separating of the media into sub-parts advantageously enables the association of different metadata to different pieces of the original media and/or the independent access of the sub-parts from the media archive (e.g., the storage device 218, the media database 115, etc.).

In some examples, the boundaries of the media are spatial boundaries (e.g., video, images, audio, etc.), temporal boundaries (e.g., time codes, relative time, frame numbers, etc.), and/or any other type of boundary for a media.

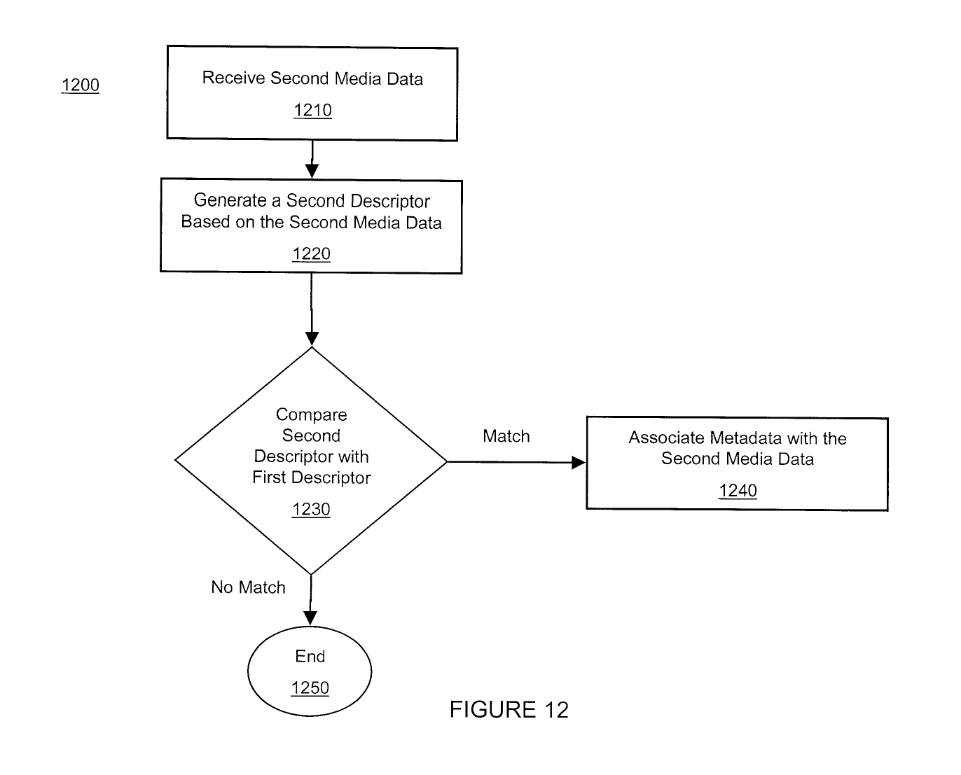

FIG. 12 illustrates an exemplary flow chart 1200 for associating metadata utilizing the system 200 of FIG. 2. The communication module 211 receives (1210) second media data. The media fingerprint module 215 generates (1220) a second descriptor based on the second media data. The media fingerprint comparison module 217 compares (1230) the second descriptor and a first descriptor. The first descriptor can be associated with a first media data that has related metadata. If the second descriptor and the first descriptor match (e.g., exact match, similar, within a percentage from each other in a relative scale, etc.), the media metadata module 216 associates (1240) at least part of the metadata with the second media data based on the comparison of the second descriptor and the first descriptor. If the second descriptor and the first descriptor do not match, the processing ends (1250).

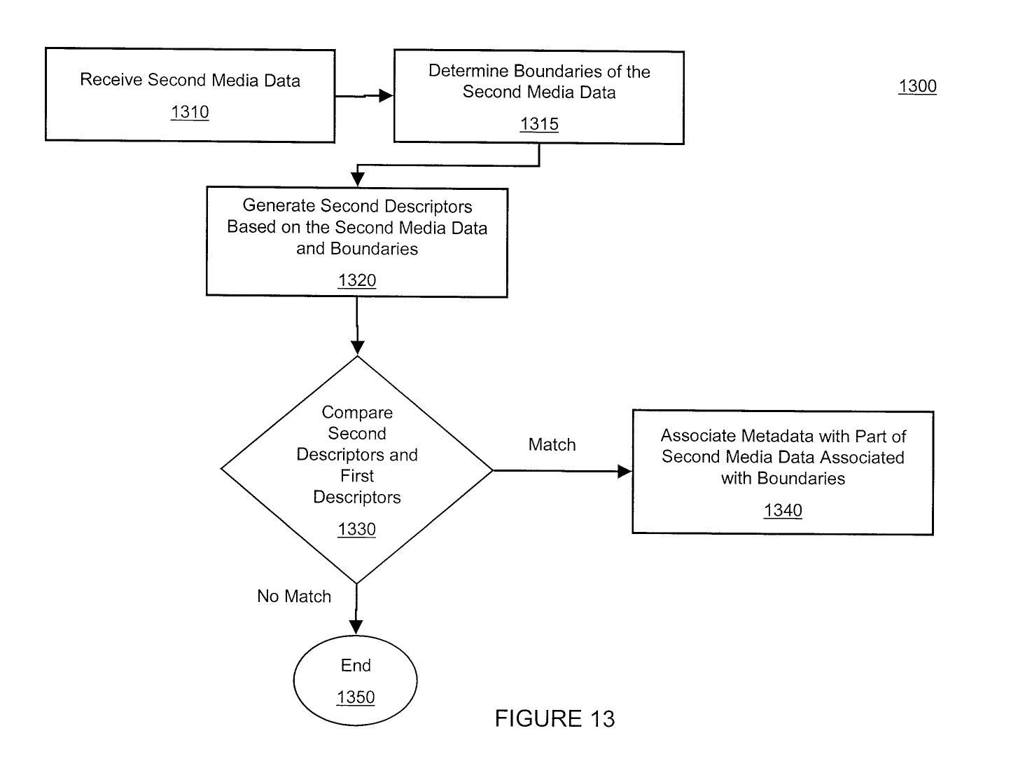

FIG. 13 illustrates another exemplary flow chart 1300 for associating metadata utilizing the system 200 of FIG. 2. The communication module 211 receives (1310) second media data. The video frame conversion module 214 determines (1315) one or more second boundaries associated with the second media data. The media fingerprint module 215 generates (1320) one or more second descriptors based on the second media data and the one or more second boundaries. The media fingerprint comparison module 217 compares (1330) the one or more second descriptors and one or more first descriptors. In some examples, each of the one or more first descriptors are associated with one or more first boundaries associated with the first media data. If one or more of the second descriptors and one or more of the first descriptors match (e.g., exact match, similar, within a percentage from each other in a relative scale, etc.), the media metadata module 216 associates (1340) at least part of the metadata with at least one of the one or more second media data sub-parts based on the comparison of the second descriptor and the first descriptor. If one or more of the second descriptors and one or more of the first descriptors do not match, the processing ends (1350).

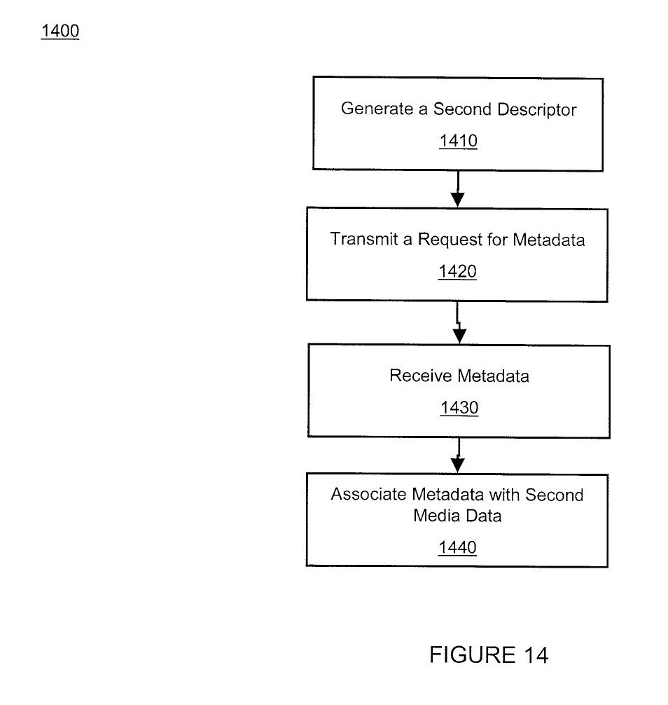

FIG. 14 illustrates another exemplary flow chart 1400 for associating metadata utilizing the system 300 of FIG. 3. The media fingerprint module 334 generates (1410) a second descriptor based on second media data. The communication module 331 transmits (1420) a request for metadata associated with the second media data, the request comprising the second descriptor. The communication module 331 receives (1430) the metadata based on the request. The metadata can be associated with at least part of the first media data. The media metadata module 337 associates (1340) metadata with the second media data based on a comparison of the second descriptor and a first descriptor associated with first media data.

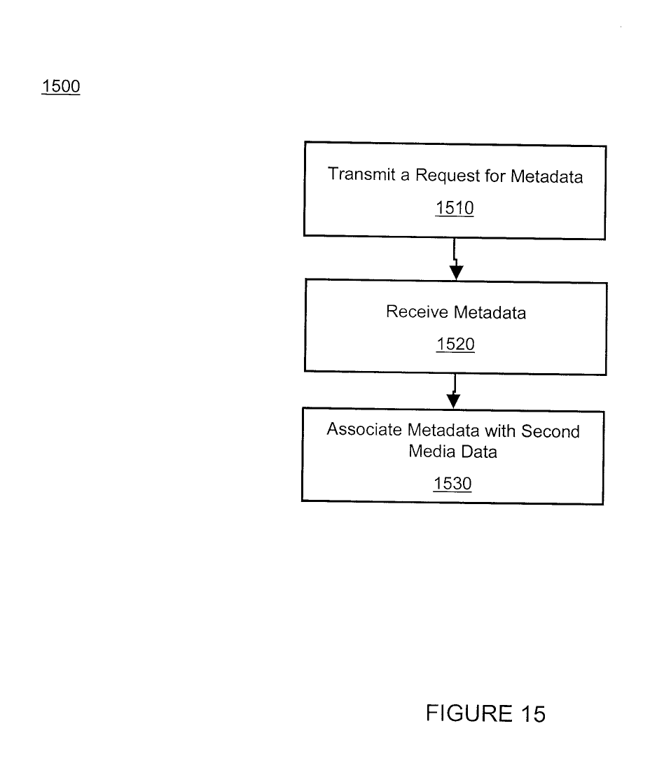

FIG. 15 illustrates another exemplary flow chart 1500 for associating metadata utilizing the system 300 of FIG. 3. The communication module 331 transmits (1510) a request for metadata associated with second media data. The request can include the second media data. The communication module 331 receives (1420) metadata based on the request. The metadata can be associated with at least part of first media data. The media metadata module 337 associates (1430) the metadata with the second media data based on a comparison of the second descriptor and a first descriptor associated with the first media data.

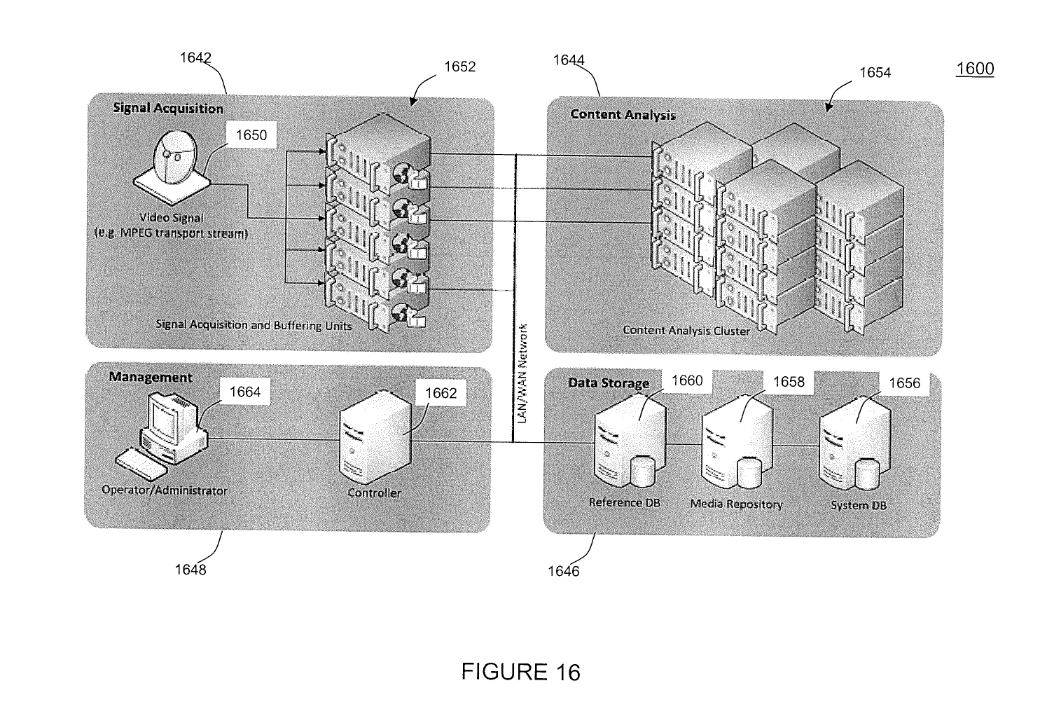

FIG. 16 illustrates a block diagram of an exemplary multi-channel video monitoring system 1600. The system 1600 includes (i) a signal, or media acquisition subsystem 1642, (ii) a content analysis subsystem 1644, (iii) a data storage subsystem 446, and (iv) a management subsystem 1648.

The media acquisition subsystem 1642 acquires one or more video signals 1650. For each signal, the media acquisition subsystem 1642 records it as data chunks on a number of signal buffer units 1652. Depending on the use case, the buffer units 1652 may perform fingerprint extraction as well, as described in more detail herein. This can be useful in a remote capturing scenario in which the very compact fingerprints are transmitted over a communications medium, such as the Internet, from a distant capturing site to a centralized content analysis site. The video detection system and processes may also be integrated with existing signal acquisition solutions, as long as the recorded data is accessible through a network connection.

The fingerprint for each data chunk can be stored in a media repository 1658 portion of the data storage subsystem 1646. In some embodiments, the data storage subsystem 1646 includes one or more of a system repository 1656 and a reference repository 1660. One or more of the repositories 1656, 1658, 1660 of the data storage subsystem 1646 can include one or more local hard-disk drives, network accessed hard-disk drives, optical storage units, random access memory (RAM) storage drives, and/or any combination thereof. One or more of the repositories 1656, 1658, 1660 can include a database management system to facilitate storage and access of stored content. In some embodiments, the system 1640 supports different SQL-based relational database systems through its database access layer, such as Oracle and Microsoft-SQL Server. Such a system database acts as a central repository for all metadata generated during operation, including processing, configuration, and status information.

In some embodiments, the media repository 1658 is serves as the main payload data storage of the system 1640 storing the fingerprints, along with their corresponding key frames. A low quality version of the processed footage associated with the stored fingerprints is also stored in the media repository 1658. The media repository 1658 can be implemented using one or more RAID systems that can be accessed as a networked file system.

Each of the data chunk can become an analysis task that is scheduled for processing by a controller 1662 of the management subsystem 1648. The controller 1662 is primarily responsible for load balancing and distribution of jobs to the individual nodes in a content analysis cluster 1654 of the content analysis subsystem 1644. In at least some embodiments, the management subsystem 1648 also includes an operator/administrator terminal, referred to generally as a front-end 1664. The operator/administrator terminal 1664 can be used to configure one or more elements of the video detection system 1640. The operator/administrator terminal 1664 can also be used to upload reference video content for comparison and to view and analyze results of the comparison.

The signal buffer units 1652 can be implemented to operate around-the-clock without any user interaction necessary. In such embodiments, the continuous video data stream is captured, divided into manageable segments, or chunks, and stored on internal hard disks. The hard disk space can be implanted to function as a circular buffer. In this configuration, older stored data chunks can be moved to a separate long term storage unit for archival, freeing up space on the internal hard disk drives for storing new, incoming data chunks. Such storage management provides reliable, uninterrupted signal availability over very long periods of time (e.g., hours, days, weeks, etc.). The controller 1662 is configured to ensure timely processing of all data chunks so that no data is lost. The signal acquisition units 1652 are designed to operate without any network connection, if required, (e.g., during periods of network interruption) to increase the system's fault tolerance.

In some embodiments, the signal buffer units 1652 perform fingerprint extraction and transcoding on the recorded chunks locally. Storage requirements of the resulting fingerprints are trivial compared to the underlying data chunks and can be stored locally along with the data chunks. This enables transmission of the very compact fingerprints including a storyboard over limited-bandwidth networks, to avoid transmitting the full video content.

In some embodiments, the controller 1662 manages processing of the data chunks recorded by the signal buffer units 1652. The controller 1662 constantly monitors the signal buffer units 1652 and content analysis nodes 1654, performing load balancing as required to maintain efficient usage of system resources. For example, the controller 1662 initiates processing of new data chunks by assigning analysis jobs to selected ones of the analysis nodes 1654. In some instances, the controller 1662 automatically restarts individual analysis processes on the analysis nodes 1654, or one or more entire analysis nodes 1654, enabling error recovery without user interaction. A graphical user interface, can be provided at the front end 1664 for monitor and control of one or more subsystems 1642, 1644, 1646 of the system 1600. For example, the graphical user interface allows a user to configure, reconfigure and obtain status of the content analysis 1644 subsystem.

In some embodiments, the analysis cluster 1644 includes one or more analysis nodes 1654 as workhorses of the video detection and monitoring system. Each analysis node 1654 independently processes the analysis tasks that are assigned to them by the controller 1662. This primarily includes fetching the recorded data chunks, generating the video fingerprints, and matching of the fingerprints against the reference content. The resulting data is stored in the media repository 1658 and in the data storage subsystem 1646. The analysis nodes 1654 can also operate as one or more of reference clips ingestion nodes, backup nodes, or RetroMatch nodes, in case the system performing retrospective matching. Generally, all activity of the analysis cluster is controlled and monitored by the controller.

After processing several such data chunks 1670, the detection results for these chunks are stored in the system database 1656. Beneficially, the numbers and capacities of signal buffer units 1652 and content analysis nodes 1654 may flexibly be scaled to customize the system's capacity to specific use cases of any kind. Realizations of the system 1600 can include multiple software components that can be combined and configured to suit individual needs. Depending on the specific use case, several components can be run on the same hardware. Alternatively or in addition, components can be run on individual hardware for better performance and improved fault tolerance. Such a modular system architecture allows customization to suit virtually every possible use case. From a local, single-PC solution to nationwide monitoring systems, fault tolerance, recording redundancy, and combinations thereof.

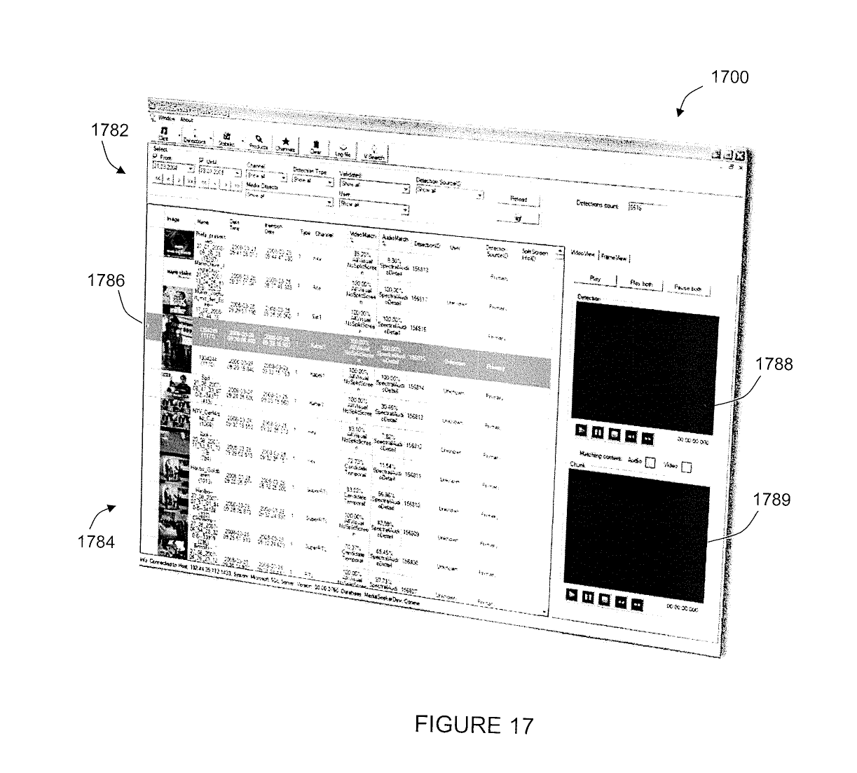

FIG. 17 illustrates a screen shot of an exemplary graphical user interface (GUI) 1700. The GUI 1700 can be utilized by operators, data annalists, and/or other users of the system 100 of FIG. 1 to operate and/or control the content analysis server 110. The GUI 1700 enables users to review detections, manage reference content, edit clip metadata, play reference and detected multimedia content, and perform detailed comparison between reference and detected content. In some embodiments, the system 1600 includes or more different graphical user interfaces, for different functions and/or subsystems such as the a recording selector, and a controller front-end 1664.

The GUI 1700 includes one or more user-selectable controls 1782, such as standard window control features. The GUI 1700 also includes a detection results table 1784. In the exemplary embodiment, the detection results table 1784 includes multiple rows 1786, one row for each detection. The row 1786 includes a low-resolution version of the stored image together with other information related to the detection itself. Generally, a name or other textual indication of the stored image can be provided next to the image. The detection information can include one or more of: date and time of detection; indicia of the channel or other video source; indication as to the quality of a match; indication as to the quality of an audio match; date of inspection; a detection identification value; and indication as to detection source. In some embodiments, the GUI 1700 also includes a video viewing window 1788 for viewing one or more frames of the detected and matching video. The GUI 1700 can include an audio viewing window 1789 for comparing indicia of an audio comparison.

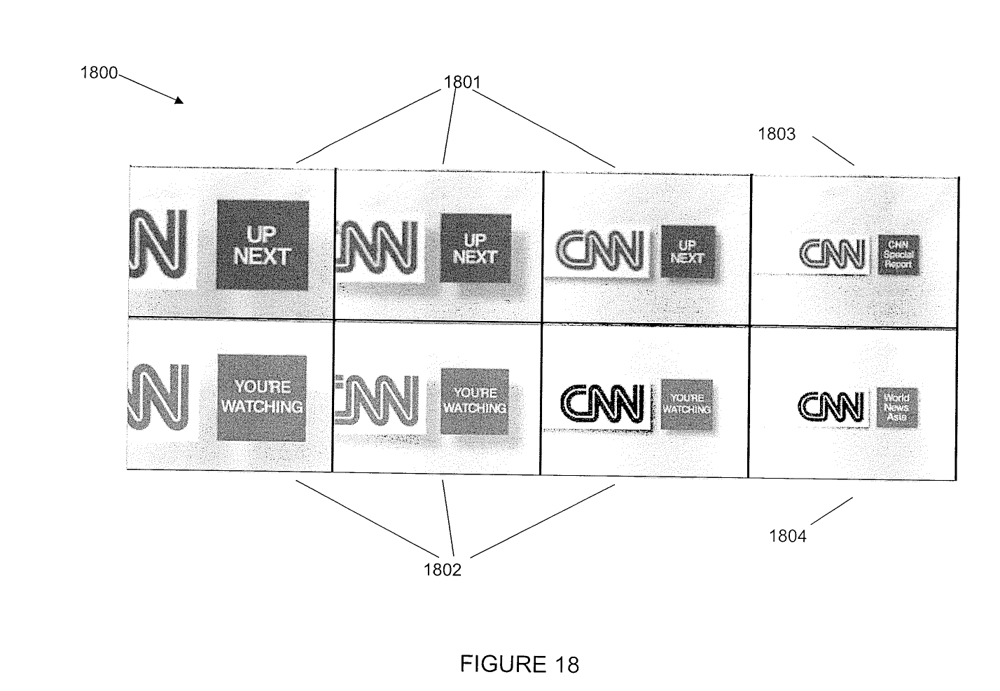

FIG. 18 illustrates an example of a change in a digital image representation subframe. A set of one of: target file image subframes and queried image subframes 1800 are shown, wherein the set 1800 includes subframe sets 1801, 1802, 1803, and 1804. Subframe sets 1801 and 1802 differ from other set members in one or more of translation and scale. Subframe sets 1802 and 1803 differ from each other, and differ from subframe sets 1801 and 1802, by image content and present an image difference to a subframe matching threshold.

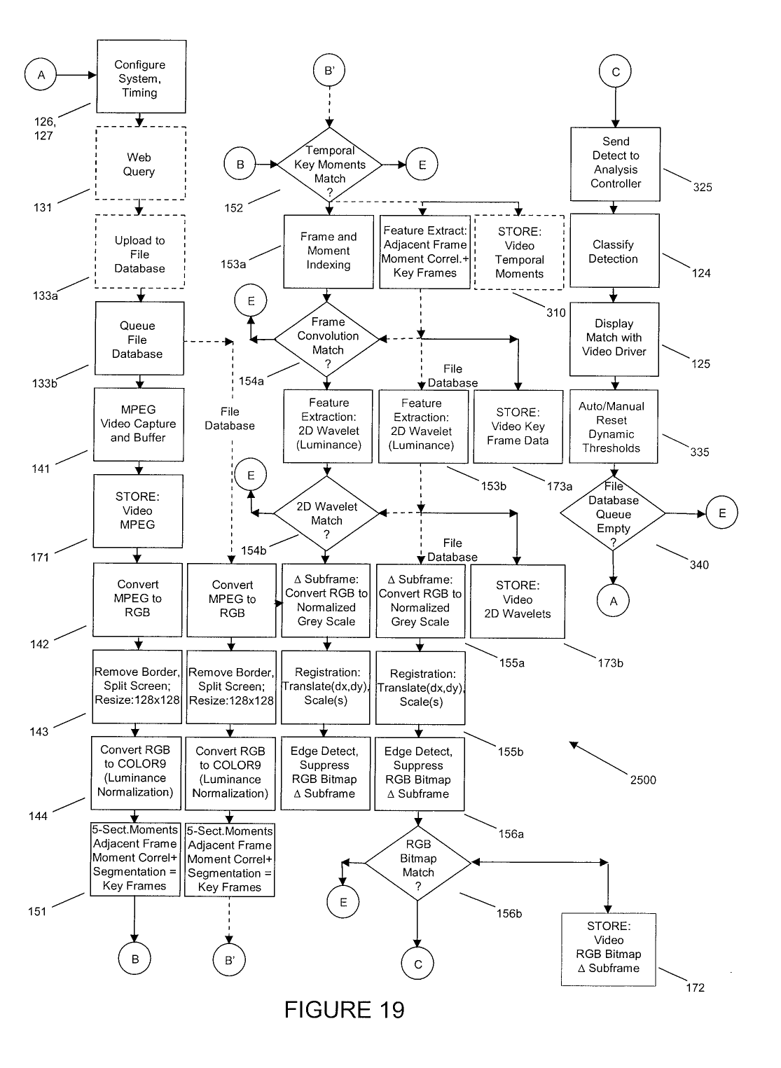

FIG. 19 illustrates an exemplary flow chart 1900 for an embodiment of the digital video image detection system 1600 of FIG. 16. The flow chart 1900 initiates at a start point A with a user at a user interface configuring the digital video image detection system 126, wherein configuring the system includes selecting at least one channel, at least one decoding method, and a channel sampling rate, a channel sampling time, and a channel sampling period. Configuring the system 126 includes one of: configuring the digital video image detection system manually and semi-automatically. Configuring the system 126 semi-automatically includes one or more of: selecting channel presets, scanning scheduling codes, and receiving scheduling feeds.

Configuring the digital video image detection system 126 further includes generating a timing control sequence 127, wherein a set of signals generated by the timing control sequence 127 provide for an interface to an MPEG video receiver.

In some embodiments, the method flow chart 1900 for the digital video image detection system 100 provides a step to optionally query the web for a file image 131 for the digital video image detection system 100 to match. In some embodiments, the method flow chart 1900 provides a step to optionally upload from the user interface 100 a file image for the digital video image detection system 100 to match. In some embodiments, querying and queuing a file database 133b provides for at least one file image for the digital video image detection system 100 to match.

The method flow chart 1900 further provides steps for capturing and buffering an MPEG video input at the MPEG video receiver and for storing the MPEG video input 171 as a digital image representation in an MPEG video archive.

The method flow chart 1900 further provides for steps of: converting the MPEG video image to a plurality of query digital image representations, converting the file image to a plurality of file digital image representations, wherein the converting the MPEG video image and the converting the file image are comparable methods, and comparing and matching the queried and file digital image representations. Converting the file image to a plurality of file digital image representations is provided by one of: converting the file image at the time the file image is uploaded, converting the file image at the time the file image is queued, and converting the file image in parallel with converting the MPEG video image.

The method flow chart 1900 provides for a method 142 for converting the MPEG video image and the file image to a queried RGB digital image representation and a file RGB digital image representation, respectively. In some embodiments, converting method 142 further comprises removing an image border 143 from the queried and file RGB digital image representations. In some embodiments, the converting method 142 further comprises removing a split screen 143 from the queried and file RGB digital image representations. In some embodiment, one or more of removing an image border and removing a split screen 143 includes detecting edges. In some embodiments, converting method 142 further comprises resizing the queried and file RGB digital image representations to a size of 128×128 pixels.

The method flow chart 1900 further provides for a method 144 for converting the MPEG video image and the file image to a queried COLOR9 digital image representation and a file COLOR9 digital image representation, respectively. Converting method 144 provides for converting directly from the queried and file RGB digital image representations.

Converting method 144 includes steps of: projecting the queried and file RGB digital image representations onto an intermediate luminance axis, normalizing the queried and file RGB digital image representations with the intermediate luminance, and converting the normalized queried and file RGB digital image representations to a queried and file COLOR9 digital image representation, respectively.

The method flow chart 1900 further provides for a method 151 for converting the MPEG video image and the file image to a queried 5-segment, low resolution temporal moment digital image representation and a file 5-segment, low resolution temporal moment digital image representation, respectively. Converting method 151 provides for converting directly from the queried and file COLOR9 digital image representations.

Converting method 151 includes steps of: sectioning the queried and file COLOR9 digital image representations into five spatial, overlapping sections and non-overlapping sections, generating a set of statistical moments for each of the five sections, weighting the set of statistical moments, and correlating the set of statistical moments temporally, generating a set of key frames or shot frames representative of temporal segments of one or more sequences of COLOR9 digital image representations.

Generating the set of statistical moments for converting method 151 includes generating one or more of: a mean, a variance, and a skew for each of the five sections. In some embodiments, correlating a set of statistical moments temporally for converting method 151 includes correlating one or more of a means, a variance, and a skew of a set of sequentially buffered RGB digital image representations.

Correlating a set of statistical moments temporally for a set of sequentially buffered MPEG video image COLOR9 digital image representations allows for a determination of a set of median statistical moments for one or more segments of consecutive COLOR9 digital image representations. The set of statistical moments of an image frame in the set of temporal segments that most closely matches the a set of median statistical moments is identified as the shot frame, or key frame. The key frame is reserved for further refined methods that yield higher resolution matches.

The method flow chart 1900 further provides for a comparing method 152 for matching the queried and file 5-section, low resolution temporal moment digital image representations. In some embodiments, the first comparing method 151 includes finding an one or more errors between the one or more of: a mean, variance, and skew of each of the five segments for the queried and file 5-section, low resolution temporal moment digital image representations. In some embodiments, the one or more errors are generated by one or more queried key frames and one or more file key frames, corresponding to one or more temporal segments of one or more sequences of COLOR9 queried and file digital image representations. In some embodiments, the one or more errors are weighted, wherein the weighting is stronger temporally in a center segment and stronger spatially in a center section than in a set of outer segments and sections.

Comparing method 152 includes a branching element ending the method flow chart 2500 at ‘E’ if the first comparing results in no match. Comparing method 152 includes a branching element directing the method flow chart 1900 to a converting method 153 if the comparing method 152 results in a match.

In some embodiments, a match in the comparing method 152 includes one or more of: a distance between queried and file means, a distance between queried and file variances, and a distance between queried and file skews registering a smaller metric than a mean threshold, a variance threshold, and a skew threshold, respectively. The metric for the first comparing method 152 can be any of a set of well known distance generating metrics.

A converting method 153a includes a method of extracting a set of high resolution temporal moments from the queried and file COLOR9 digital image representations, wherein the set of high resolution temporal moments include one or more of: a mean, a variance, and a skew for each of a set of images in an image segment representative of temporal segments of one or more sequences of COLOR9 digital image representations.

Converting method 153a temporal moments are provided by converting method 151. Converting method 153a indexes the set of images and corresponding set of statistical moments to a time sequence. Comparing method 154a compares the statistical moments for the queried and the file image sets for each temporal segment by convolution.

The convolution in comparing method 154a convolves the queried and filed one or more of: the first feature mean, the first feature variance, and the first feature skew. In some embodiments, the convolution is weighted, wherein the weighting is a function of chrominance. In some embodiments, the convolution is weighted, wherein the weighting is a function of hue.

The comparing method 154a includes a branching element ending the method flow chart 1900 if the first feature comparing results in no match. Comparing method 154a includes a branching element directing the method flow chart 1900 to a converting method 153b if the first feature comparing method 153a results in a match.

In some embodiments, a match in the first feature comparing method 153a includes one or more of: a distance between queried and file first feature means, a distance between queried and file first feature variances, and a distance between queried and file first feature skews registering a smaller metric than a first feature mean threshold, a first feature variance threshold, and a first feature skew threshold, respectively. The metric for the first feature comparing method 153a can be any of a set of well known distance generating metrics.

The converting method 153b includes extracting a set of nine queried and file wavelet transform coefficients from the queried and file COLOR9 digital image representations. Specifically, the set of nine queried and file wavelet transform coefficients are generated from a grey scale representation of each of the nine color representations comprising the COLOR9 digital image representation. In some embodiments, the grey scale representation is approximately equivalent to a corresponding luminance representation of each of the nine color representations comprising the COLOR9 digital image representation. In some embodiments, the grey scale representation is generated by a process commonly referred to as color gamut sphering, wherein color gamut sphering approximately eliminates or normalizes brightness and saturation across the nine color representations comprising the COLOR9 digital image representation.

In some embodiments, the set of nine wavelet transform coefficients are one of: a set of nine one-dimensional wavelet transform coefficients, a set of one or more non-collinear sets of nine one-dimensional wavelet transform coefficients, and a set of nine two-dimensional wavelet transform coefficients. In some embodiments, the set of nine wavelet transform coefficients are one of: a set of Haar wavelet transform coefficients and a two-dimensional set of Haar wavelet transform coefficients.

The method flow chart 1900 further provides for a comparing method 154b for matching the set of nine queried and file wavelet transform coefficients. In some embodiments, the comparing method 154b includes a correlation function for the set of nine queried and filed wavelet transform coefficients. In some embodiments, the correlation function is weighted, wherein the weighting is a function of hue; that is, the weighting is a function of each of the nine color representations comprising the COLOR9 digital image representation.

The comparing method 154b includes a branching element ending the method flow chart 1900 if the comparing method 154b results in no match. The comparing method 154b includes a branching element directing the method flow chart 1900 to an analysis method 155a-156b if the comparing method 154b results in a match.

In some embodiments, the comparing in comparing method 154b includes one or more of: a distance between the set of nine queried and file wavelet coefficients, a distance between a selected set of nine queried and file wavelet coefficients, and a distance between a weighted set of nine queried and file wavelet coefficients.

The analysis method 155a-156b provides for converting the MPEG video image and the file image to one or more queried RGB digital image representation subframes and file RGB digital image representation subframes, respectively, one or more grey scale digital image representation subframes and file grey scale digital image representation subframes, respectively, and one or more RGB digital image representation difference subframes. The analysis method 155a-156b provides for converting directly from the queried and file RGB digital image representations to the associated subframes.

The analysis method 55a-156b provides for the one or more queried and file grey scale digital image representation subframes 155a, including: defining one or more portions of the queried and file RGB digital image representations as one or more queried and file RGB digital image representation subframes, converting the one or more queried and file RGB digital image representation subframes to one or more queried and file grey scale digital image representation subframes, and normalizing the one or more queried and file grey scale digital image representation subframes.

The method for defining includes initially defining identical pixels for each pair of the one or more queried and file RGB digital image representations. The method for converting includes extracting a luminance measure from each pair of the queried and file RGB digital image representation subframes to facilitate the converting. The method of normalizing includes subtracting a mean from each pair of the one or more queried and file grey scale digital image representation subframes.

The analysis method 155a-156b further provides for a comparing method 155b-156b. The comparing method 155b-156b includes a branching element ending the method flow chart 2500 if the second comparing results in no match. The comparing method 155b-156b includes a branching element directing the method flow chart 2500 to a detection analysis method 325 if the second comparing method 155b-156b results in a match.

The comparing method 155b-156b includes: providing a registration between each pair of the one or more queried and file grey scale digital image representation subframes 155b and rendering one or more RGB digital image representation difference subframes and a connected queried RGB digital image representation dilated change subframe 156a-b.

The method for providing a registration between each pair of the one or more queried and file grey scale digital image representation subframes 155b includes: providing a sum of absolute differences (SAD) metric by summing the absolute value of a grey scale pixel difference between each pair of the one or more queried and file grey scale digital image representation subframes, translating and scaling the one or more queried grey scale digital image representation subframes, and repeating to find a minimum SAD for each pair of the one or more queried and file grey scale digital image representation subframes. The scaling for method 155b includes independently scaling the one or more queried grey scale digital image representation subframes to one of: a 128×128 pixel subframe, a 64×64 pixel subframe, and a 32×32 pixel subframe.

The scaling for method 155b includes independently scaling the one or more queried grey scale digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method for rendering one or more RGB digital image representation difference subframes and a connected queried RGB digital image representation dilated change subframe 156a-b includes: aligning the one or more queried and file grey scale digital image representation subframes in accordance with the method for providing a registration 155b, providing one or more RGB digital image representation difference subframes, and providing a connected queried RGB digital image representation dilated change subframe.

The providing the one or more RGB digital image representation difference subframes in method 56a includes: suppressing the edges in the one or more queried and file RGB digital image representation subframes, providing a SAD metric by summing the absolute value of the RGB pixel difference between each pair of the one or more queried and file RGB digital image representation subframes, and defining the one or more RGB digital image representation difference subframes as a set wherein the corresponding SAD is below a threshold.

The suppressing includes: providing an edge map for the one or more queried and file RGB digital image representation subframes and subtracting the edge map for the one or more queried and file RGB digital image representation subframes from the one or more queried and file RGB digital image representation subframes, wherein providing an edge map includes providing a Sobol filter.

The providing the connected queried RGB digital image representation dilated change subframe in method 56a includes: connecting and dilating a set of one or more queried RGB digital image representation subframes that correspond to the set of one or more RGB digital image representation difference subframes.

The method for rendering one or more RGB digital image representation difference subframes and a connected queried RGB digital image representation dilated change subframe 156a-b includes a scaling for method 156a-b independently scaling the one or more queried RGB digital image representation subframes to one of: a 128×128 pixel subframe, a 64×64 pixel subframe, and a 32×32 pixel subframe.

The scaling for method 156a-b includes independently scaling the one or more queried RGB digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method flow chart 1900 further provides for a detection analysis method 325. The detection analysis method 325 and the associated classify detection method 124 provide video detection match and classification data and images for the display match and video driver 125, as controlled by the user interface 110. The detection analysis method 325 and the classify detection method 124 further provide detection data to a dynamic thresholds method 335, wherein the dynamic thresholds method 335 provides for one of: automatic reset of dynamic thresholds, manual reset of dynamic thresholds, and combinations thereof.

The method flow chart 1900 further provides a third comparing method 340, providing a branching element ending the method flow chart 1900 if the file database queue is not empty.

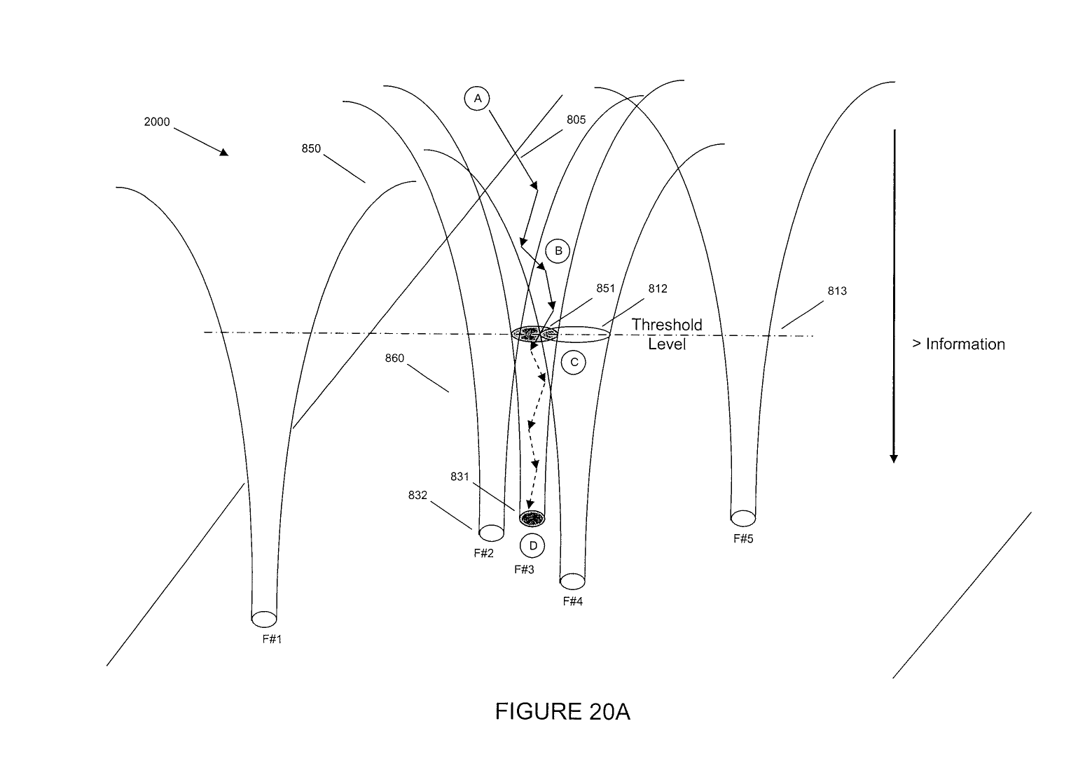

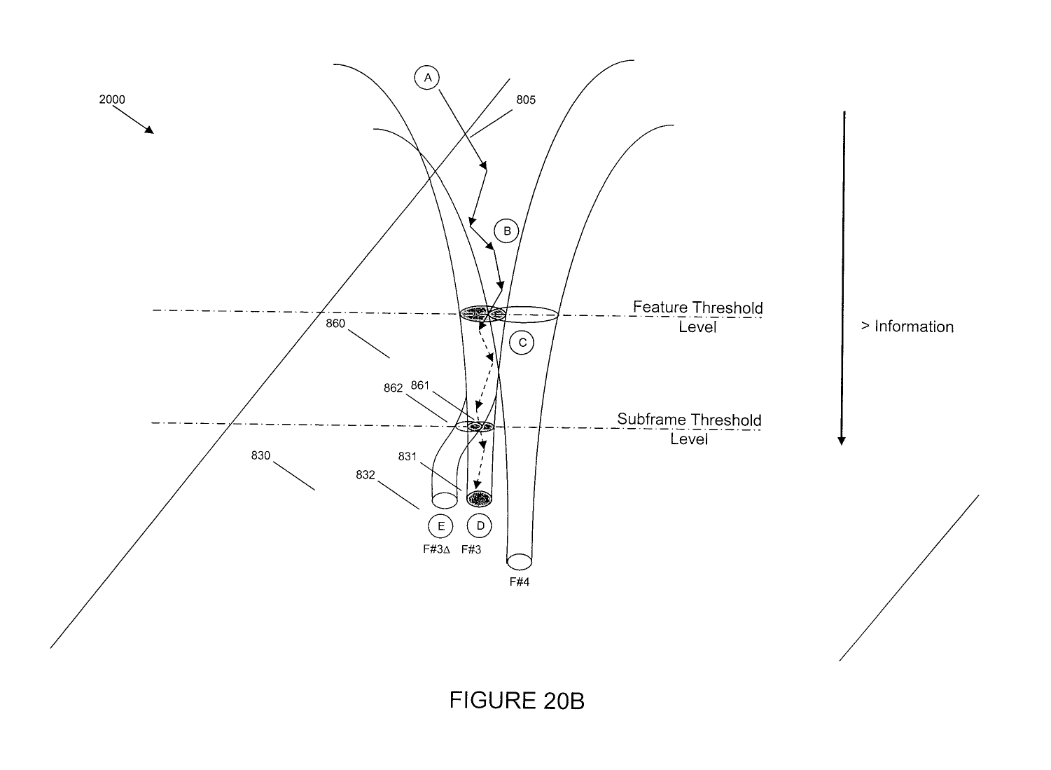

FIG. 20A illustrates an exemplary traversed set of K-NN nested, disjoint feature subspaces in feature space 2000. A queried image 805 starts at A and is funneled to a target file image 831 at D, winnowing file images that fail matching criteria 851 and 852, such as file image 832 at threshold level 813, at a boundary between feature spaces 850 and 860.

FIG. 20B illustrates the exemplary traversed set of K-NN nested, disjoint feature subspaces with a change in a queried image subframe. The a queried image 805 subframe 861 and a target file image 831 subframe 862 do not match at a subframe threshold at a boundary between feature spaces 860 and 830. A match is found with file image 832, and a new subframe 832 is generated and associated with both file image 831 and the queried image 805, wherein both target file image 831 subframe 961 and new subframe 832 comprise a new subspace set for file target image 832.

In some examples, the content analysis server 110 of FIG. 1 is a Web portal. The Web portal implementation allows for flexible, on demand monitoring offered as a service. With need for little more than web access, a web portal implementation allows clients with small reference data volumes to benefit from the advantages of the video detection systems and processes of the present invention. Solutions can offer one or more of several programming interfaces using Microsoft .Net Remoting for seamless in-house integration with existing applications. Alternatively or in addition, long-term storage for recorded video data and operative redundancy can be added by installing a secondary controller and secondary signal buffer units.

Fingerprint extraction is described in more detail in International Patent Application Serial No. PCT/US2008/060164, Publication No. WO2008/128143, entitled “Video Detection System And Methods,” incorporated herein by reference in its entirety. Fingerprint comparison is described in more detail in International Patent Application Serial No. PCT/US2009/035617, entitled “Frame Sequence Comparisons in Multimedia Streams,” incorporated herein by reference in its entirety.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of data processing apparatus. The implementation can, for example, be a programmable processor, a computer, and/or multiple computers.

A computer program can be written in any form of programming language, including compiled and/or interpreted languages, and the computer program can be deployed in any faun, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

In general, the term video refers to a sequence of still images, or frames, representing scenes in motion. Thus, the video frame itself is a still picture. The terms video and multimedia as used herein include television and film-style video clips and streaming media. Video and multimedia include analog formats, such as standard television broadcasting and recording and digital formats, also including standard television broadcasting and recording (e.g., DTV). Video can be interlaced or progressive. The video and multimedia content described herein may be processed according to various storage formats, including: digital video formats (e.g., DVD), QuickTime®, and MPEG 4; and analog videotapes, including VHS® and Betamax®. Formats for digital television broadcasts may use the MPEG-2 video codec and include: ATSC—USA, Canada DVB—Europe ISDB—Japan, Brazil DMB—Korea. Analog television broadcast standards include: FCS—USA, Russia; obsolete MAC—Europe; obsolete MUSE—Japan NTSC—USA, Canada, Japan PAL—Europe, Asia, Oceania PAL-M—PAL variation. Brazil PALplus—PAL extension, Europe RS-343 (military) SECAM—France, Former Soviet Union, Central Africa. Video and multimedia as used herein also include video on demand referring to videos that start at a moment of the user's choice, as opposed to streaming, multicast.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of media asset management, comprising:
receiving second media data;
generating a second descriptor based on the second media data;
comparing the second descriptor with a first descriptor, the first descriptor associated with first media data having related metadata; and
associating at least part of the metadata with the second media data based on the comparison of the second descriptor and the first descriptor.

2. The method of claim 1, further comprising:
determining one or more second boundaries associated with the second media data; and
generating one or more second descriptors based on the second media data and the one or more second boundaries.

3. The method of claim 2, wherein the comparing the second descriptor and the first descriptor further comprising comparing the one or more second descriptors and one or more first descriptors, each of the one or more first descriptors associated with one or more first boundaries associated with the first media data.

4. The method of claim 2, wherein the one or more second boundaries comprising a spatial boundary, a temporal boundary, or any combination thereof.

5. The method of claim 2, further comprising separating the second media data into one or more second media data sub-parts based on the one or more second boundaries.

6. The method of claim 5, wherein the associating at least part of the metadata with the second media data further comprising associating at least part of the metadata with at least one of the one or more second media data sub-parts based on the comparison of the second descriptor and the first descriptor.

7. The method of claim 1, wherein the second media data comprises all or part of the first media data.

8. The method of claim 1, wherein the second descriptor is similar to part or all of the first descriptor.

9. The method of claim 1, further comprising:
receiving the first media data and the metadata associated with the first media data; and
generating the first descriptor based on the first media data.

10. The method of claim 9, further comprising associating at least part of the metadata with the first descriptor.

11. The method of claim 10, further comprising:
storing the metadata, the first descriptor, and the association of the at least part of the metadata with the first descriptor; and
retrieving the stored metadata, the stored first descriptor, and the stored association of the at least part of the metadata with the first descriptor.

12. The method of claim 9, further comprising:
determining one or more first boundaries associated with the first media data; and
generating one or more first descriptors based on the first media data and the one or more first boundaries.

13. The method of claim 12, further comprising:
separating the metadata associated with the first media data into one or more metadata sub-parts based on the one or more first boundaries; and
associating the one or more metadata sub-parts with the one or more first descriptors based on the one or more first boundaries.

14. The method of claim 1, further comprising associating the metadata and the first descriptor.

15. The method of claim 1, wherein the first media data comprising video.

16. The method of claim 1, wherein the first media data comprising video, audio, text, an image, or any combination thereof.

17. A method of media asset management, comprising:
generating a second descriptor based on second media data;
transmitting a request for metadata associated with the second media data, the request comprising the second descriptor;
receiving metadata based on the request, the metadata associated with at least part of a first media data; and
associating the metadata with the second media data based on a comparison of the second descriptor and a first descriptor associated with the first media data.

18. The method of claim 17, wherein the second media data comprises all or part of first media data.

19. The method of claim 17, wherein the second descriptor is similar to part or all of the first descriptor.

20. The method of claim 17, wherein the first media data comprising video.

21. The method of claim 17, wherein the first media data comprising video, audio, text, an image, or any combination thereof.

22. A method of media asset management, comprising:
transmitting a request for metadata associated with second media data, the request comprising the second media data;
receiving metadata based on the request, the metadata associated with at least part of first media data; and
associating the metadata with the second media data based on a comparison of the second descriptor and a first descriptor associated with the first media data.

23. The method of claim 22, wherein the second media data comprises all or part of the first media data.

24. The method of claim 22, wherein the second descriptor is similar to part or all of the first descriptor.

25. The method of claim 22, wherein the first media data comprising video.

26. The method of claim 22, wherein the first media data comprising video, audio, text, an image, or any combination thereof.

27. A computer program product, tangibly embodied in an information carrier, the computer program product including instructions being operable to cause a data processing apparatus to:
receive second media data;
generate a second descriptor based on the second media data;
compare the second descriptor with a first descriptor, the first descriptor associated with first media data having related metadata; and
associate at least part of the metadata with the second media data based on the comparison of the second descriptor and the first descriptor.

28. A system of media asset management, comprising:
a communication module to receive second media data;
a media fingerprint module to generate a second descriptor based on the second media data;
a media fingerprint comparison module to compare the second descriptor and a first descriptor, the first descriptor associated with a first media data having related metadata; and
a media metadata module to associate at least part of the metadata with the second media data based on the comparison of the second descriptor and the first descriptor.

29. The system of claim 28, further comprising:
a video frame conversion module to determine one or more second boundaries associated with the second media data; and
the media fingerprint module to generate one or more second descriptors based on the second media data and the one or more second boundaries.

30. The system of claim 29, further comprising the media fingerprint comparison module to compare the one or more second descriptors and one or more first descriptors, each of the one or more first descriptors associated with one or more first boundaries associated with the first media data.

31. The system of claim 29, further comprising the video frame conversion module to separate the second media data into one or more second media data sub-parts based on the one or more second boundaries.

32. The system of claim 29, further comprising the media metadata module to associate at least part of the metadata with at least one of the one or more second media data sub-parts based on the comparison of the second descriptor and the first descriptor.

33. The system of claim 28, further comprising:
the communication module to receive the first media data and the metadata associated with the first media data; and
the media fingerprint module to generate the first descriptor based on the first media data.

34. The system of claim 33, further comprising the media metadata module to associate at least part of the metadata with the first descriptor.

35. The system of claim 34, further comprising:
a storage device to:
store the metadata, the first descriptor, and the association of the at least part of the metadata with the first descriptor; and
retrieve the stored metadata, the stored first descriptor, and the stored association of the at least part of the metadata with the first descriptor.

36. The system of claim 35, further comprising:
the video conversion module to determine one or more first boundaries associated with the first media data; and
the media fingerprint module to generate one or more first descriptors based on the first media data and the one or more first boundaries.

37. The system of claim 36, further comprising:
the video conversion module to separate the metadata associated with the first media data into one or more metadata sub-parts based on the one or more first boundaries; and
the media metadata module to associate the one or more metadata sub-parts with the one or more first descriptors based on the one or more first boundaries.

38. The system of claim 28, further comprising the media metadata module to associate the metadata and the first descriptor.

39. A system of media asset management, comprising:
a media fingerprint module to generate a second descriptor based on second media data;
a communication module to:
transmit a request for metadata associated with the second media data, the request comprising the second descriptor, and
receive the metadata based on the request, the metadata associated with at least part of the first media data; and
a media metadata module to associate metadata with the second media data based on a comparison of the second descriptor and a first descriptor associated with first media data.

40. A system of media asset management, comprising:
a communication module to:
transmit a request for metadata associated with second media data, the request comprising the second media data, and
receive metadata based on the request, the metadata associated with at least part of first media data; and
a media metadata module to associate the metadata with the second media data based on a comparison of the second descriptor and a first descriptor associated with the first media data.

41. A system of media asset management, comprising:
means for receiving second media data;
means for generating a second descriptor based on the second media data;
means for comparing the second descriptor and a first descriptor, the first descriptor associated with a first media data having related metadata; and
means for associating at least part of the metadata with the second media data based on the comparison of the second descriptor and the first descriptor.
